(19) United States
(12) Patent Application Publication
(10) Pub. No.: US 2012/0084372 A1
(43) Pub. Date: Apr. 5, 2012

(54) SYSTEM AND METHOD FOR PROVIDING INFORMATION IN A NETWORK

(76) Inventor: Adam Isaac Michael Cohen, (US)

(21) Appl. No.: 13/250,222

(22) Filed: Sep. 30, 2011

Related U.S. Application Data
(60) Provisional application No. 61/389,204, filed on Oct. 2, 2010.

(51) Int. Cl. G06F 15/16

(52) U.S. Cl. 709/206

(57) ABSTRACT

A method for providing information in a network includes receiving in a network at least some personal interest information of a first user, determining at least one goal for the first user wherein the at least one goal is correlated to the at least some personal interest information of the first user and at least some personal interest information and at least one goal of at least a second user in the network, and displaying to the first user the at least one goal and the at least one list item.

### RELATED APPLICATIONS

The present application claims priority to U.S. Provisional Patent Application entitled “SYSTEM AND METHOD FOR PROVIDING INFORMATION IN A SOCIAL NETWORK,” Ser. No. 61/389,204 filed on Oct. 2, 2010.

### BACKGROUND

1) Field of the Invention

The invention relates to a system and a method for providing information to a user in a network. More particularly, the invention is directed to a social network for mutual help, an avenue for people who want to join a community to help themselves and others achieve goals of almost any nature.

2) Discussion of the Related Art

The MySpace® social networking model was essentially perfected (and, eventually, surpassed) by Facebook®. The Facebook® model allowed users from diverse social, economic, and geographical backgrounds to meet and engage with others of similar interest online.

Facebook® alone has a social network that currently numbers over 500 million users, with new members joining everyday. In spite of this, one of the greatest challenges that sites such as these face continues to center around making money on the high-traffic, social networking business model.

Although the market for social interaction outlets is as vast as the users that make these sites popular, all too often, networking sites do little to encourage or engage the users in a proactive manner. Such sites find themselves in an ongoing debate concerning whether or not they can be considered time wasters that cut into employee performance, student productivity, and more.

Many sites have sought to address that question; offering a variety of platforms where users can interact and make the most of the time they do spend online, setting and meeting goals of their choosing with the feedback and support of the user community. However, no sites have figured out how to satisfactorily proactively engage the user.

### SUMMARY

The system aims, in one embodiment, to express the suggestion of activity, objectives, otherwise considered “goals” herein, to users and at the same time suggest the most effective “to-do” list for each goal while taking into account a user's profile, specification and interaction with the system. Each suggestion is compiled, designed and built off prior users interaction with the system as described herein.

In an embodiment, the system can create a task list designed off the aforementioned and will schedule these tasks in the specific user's personalized calendar including embedding the functionality of reminders to notify users of scheduled tasks and helping them to stay on track with their proposed objective or goal.

The system enables users to tailor their online experience by creating, their own path to success or opting to take advantage of existing paths suggested to that user by the system with the added flexibility of modifying the plan to fit their specific goal(s). Where new interests lead to new friends and positive growth.

In an embodiment,the system provides a community-rated system that encourages current users to rank to-do lists and allows new users to determine the efficacy of these lists based on others' experience and additional data. Lists grow and change organically through repeated utilization and ratings system feedback and essentially actively promotes on-site those lists that receive the most favorable rankings, thus taking the guesswork out of accomplishing a goal and providing users with tried and tested ways to reach their goals, at their discretion and according to their unique needs and preferences.

### BRIEF DESCRIPTION OF THE DRAWINGS

The invention is described by way of example with reference to the accompanying drawings where:

FIG. 1 illustrates an embodiment of a graphical user interface.

FIG. 2 illustrates an embodiment showing goal images on the graphical user interface.

FIG. 3A illustrates a feature in an embodiment of the goal images graphical user interface.

FIG. 3B illustrates an example of a user interacting with an embodiment of the graphical user interface.

FIG. 3C illustrates an example of a user interacting with an embodiment of the graphical user interface.

FIG. 4 illustrates an embodiment of a registration graphical user interface.

FIG. 5 illustrates an embodiment of a registration graphical user interface.

FIG. 6 illustrates an embodiment of a registration graphical user interface.

FIG. 7 illustrates an embodiment of a registration graphical user interface.

FIG. 8 illustrates an embodiment of a toolbox associated with an embodiment of the graphical user interface.

FIG. 9A illustrates an embodiment of a personal user page feature associated with an embodiment of the graphical user interface.

FIG. 9B illustrates an embodiment of a feature associated with an embodiment of the graphical user interface.

FIG. 10 illustrates an embodiment of a feature associated with an embodiment of the graphical user interface.

FIG. 11 illustrates an embodiment of a feature associated with an embodiment of the graphical user interface.

FIG. 12 illustrates an embodiment of a feature associated with an embodiment of the graphical user interface.

FIG. 13 illustrates an embodiment of a feature associated with an embodiment of the graphical user interface.

FIG. 14 illustrates an embodiment of a feature associated with an embodiment of the graphical user interface.

FIG. 15A illustrates an embodiment of a feature associated with an embodiment of the graphical user interface.

FIG. 15B illustrates an embodiment of a feature associated with an embodiment of the graphical user interface.

FIG. 15C illustrates an embodiment of a feature associated with an embodiment of the graphical user interface.

FIG. 15D illustrates an embodiment of a feature associated with an embodiment of the graphical user interface.

FIG. 15E illustrates an embodiment of a feature associated with an embodiment of the graphical user interface.

FIG. 15F illustrates an embodiment of a feature associated with an embodiment of the graphical user interface.

FIG. 15G illustrates an embodiment of a feature associated with an embodiment of the graphical user interface.

FIG. 15H illustrates an embodiment of a feature associated with an embodiment of the graphical user interface.

FIG. 16A illustrates an embodiment of a feature associated with an embodiment of the graphical user interface.

FIG. 16B illustrates an embodiment of a feature associated with an embodiment of the graphical user interface.

FIG. 16C illustrates an embodiment of a feature associated with an embodiment of the graphical user interface.

FIG. 17 illustrates an embodiment of a feature associated with an embodiment of the graphical user interface.

FIG. 18 illustrates an embodiment of a feature associated with an embodiment of the graphical user interface.

FIG. 19A illustrates an embodiment of a feature associated with an embodiment of the graphical user interface.

FIG. 19B illustrates an embodiment of a feature associated with an embodiment of the graphical user interface.

FIG. 20 illustrates an embodiment of a feature associated with an embodiment of the graphical user interface.

FIG. 21 illustrates an embodiment of a feature associated with an embodiment of the graphical user interface.

FIG. 22 illustrates an embodiment of a feature associated with an embodiment of the graphical user interface.

FIG. 23A illustrates an embodiment of a feature associated with an embodiment of the graphical user interface.

FIG. 23B illustrates an embodiment of a feature associated with an embodiment of the graphical user interface.

FIG. 23C illustrates an embodiment of a feature associated with an embodiment of the graphical user interface.

FIG. 23D illustrates an embodiment of a feature associated with an embodiment of the graphical user interface.

FIG. 23E illustrates an embodiment of a feature associated with an embodiment of the graphical user interface.

FIG. 23F illustrates an embodiment of a feature associated with an embodiment of the graphical user interface.

FIG. 23G illustrates an embodiment of a feature associated with an embodiment of the graphical user interface.

FIG. 23H illustrates an embodiment of a feature associated with an embodiment of the graphical user interface.

FIG. 24A illustrates an embodiment of a feature associated with an embodiment of the graphical user interface.

FIG. 24B illustrates an embodiment of a feature associated with an embodiment of the graphical user interface.

FIG. 24C illustrates an embodiment of a feature associated with an embodiment of the graphical user interface.

FIG. 25 illustrates an embodiment of a feature associated with an embodiment of the graphical user interface.

FIG. 26 illustrates an embodiment of a feature associated with an embodiment of the graphical user interface.

FIG. 27 illustrates an embodiment of a feature associated with an embodiment of the graphical user interface.

FIG. 28A illustrates an embodiment of a feature associated with an embodiment of the graphical user interface.

FIG. 28B illustrates an embodiment of a feature associated with an embodiment of the graphical user interface.

FIG. 29 illustrates an embodiment of a feature associated with an embodiment of the graphical user interface.

FIG. 30 illustrates an embodiment of a feature associated with an embodiment of the graphical user interface.

FIG. 31 illustrates an embodiment of a feature associated with an embodiment of the graphical user interface.

### DETAILED DESCRIPTION OF THE INVENTION

The following detailed description represents the best currently contemplated modes for carrying out the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Aspects of the invention are implemented in computer program instructions through specific client-server architecture and special purpose computers, and in some embodiments executed through a network or the World Wide Web. These computer program instructions may be provided to a processor of a general purpose computer, special purpose computer, Application Specific Integrated Circuit (“ASIC”), or other programmable data processing apparatus, such that the instructions, which execute via the processor of the computer or other programmable data processing apparatus, implements the functions/acts specified in the block diagrams or operational block or blocks.

The Web used herein refers generally to both (i) a distributed collection of interlinked, user-viewable hypertext documents (commonly referred to as web documents or web pages) that are accessible via the Internet, and (ii) the client and server software components which provide user access to such documents using standardized Internet protocols. The primary standard protocol for allowing applications to locate and acquire web documents is HTTP, and the web pages are encoded using HTML. However, the terms “Web” and “World Wide Web” are intended to encompass markup languages and transport protocols which may be used in place of (or in addition to) HTML and HTTP.

References to the term “goals” can generally include any type of activity, objective or desire set forth by the user in which each of the aforementioned includes a step or series of steps to accomplish. As such, continued usage of the term it shall not be deemed limiting in any sense.

Generally, the invention provides users the ability to identify and define a goal or goals they wish to achieve or use the invention to assist others in reaching their personal goals. A list of goals will be available to choose from, searched and/or suggested. Users may create their own path to success or opt to take advantage of existing paths with the flexibility to modify the plan to fit their specific goal/goals. Users of the invention generally would also use the invention if that person has a mutual interest in helping others.

As set forth in detail below, the Goal Images Logo area contains thumbnails of the users goal/goals, allowing each user to monitor their specific goals, creating a “goal profile.” This logo area, unique to each user will continually morph as goals are added or deleted. The user can choose to have only one goal or a multitude of goals—there is no limit. Goals can be as simplistic as making an appointment or as complex as flying to the moon. The thumbnail will transport the user to that specific goal page.

The system includes the capability to analyze its users specifically by goal as well as by the unique characteristics of the user and the goal. When a user chooses their goal, they will automatically receive a “to-do” list, tailor-made to fit their profile, i.e.: sex and age. In addition, the user will have the option to visit the Main Goal Page (as set forth below) and view other “to-do's”, such as generic, beginner, aggressive, etc. The user will have the ability to tailor their goal path because the system provides the capability to modify their specific “to-do” list.

In an embodiment, the system will mathematically create averages of the most effective “to-do's” for each goal while taking into account users specificities. To illustrate: a 22 year old male will potentially have a more aggressive To-Do list than a 45 year old woman, who both have a goal to kayak 20 miles in the ocean. The viability of a “To-Do” relies on sufficient populations and success rates. If a user creates a “To-Do” list, which may be out of the ordinary, our system will take it into account for the purpose of processing it with our statistics. The invention will rate “To-Do's” as to their effectiveness in accomplishing a specific goal(s).

Users may pick any subject for a goal as long as there are enough other users interested in the subject to create interactivity, thereby inducing organic growth. If a user is struggling with a goal or a “To-Do”, they can post questions on the Main Goal page and get help. The answers will be posted on the Main Goal page as well as on the users Personal Goal page. The interactivity between users will create a natural evolution to a social network by connecting users of like goals with each other. In an embodiment, the invention will provide suggested “friends” based upon common interests.

Rather than asking users to share their interests or describe who they are, the invention will surface the user's interests over time without the prejudices and biases of the user. The invention will create data based on the users actual goal profile. This unique ability provides for the invention to enhance its potential to monetize by providing advertisers opportunities to market to a more refined and accurate target audience based on user's goal profiles and “To-Do's”.

As a mutual help society, the invention's prime mission is to provide its members the opportunity to achieve goals. Whether a user has one simple goal or a multitude of complex and long-term goals, the invention will provide the user with tools and avenues for success. Besides managing tasks, the invention will encourage its users to grow their community by including their existing friends, address books and calendars in their personal user page. The expectation and goal will be to have created a site that allows users to control and manage their life.

### 1. Home Page

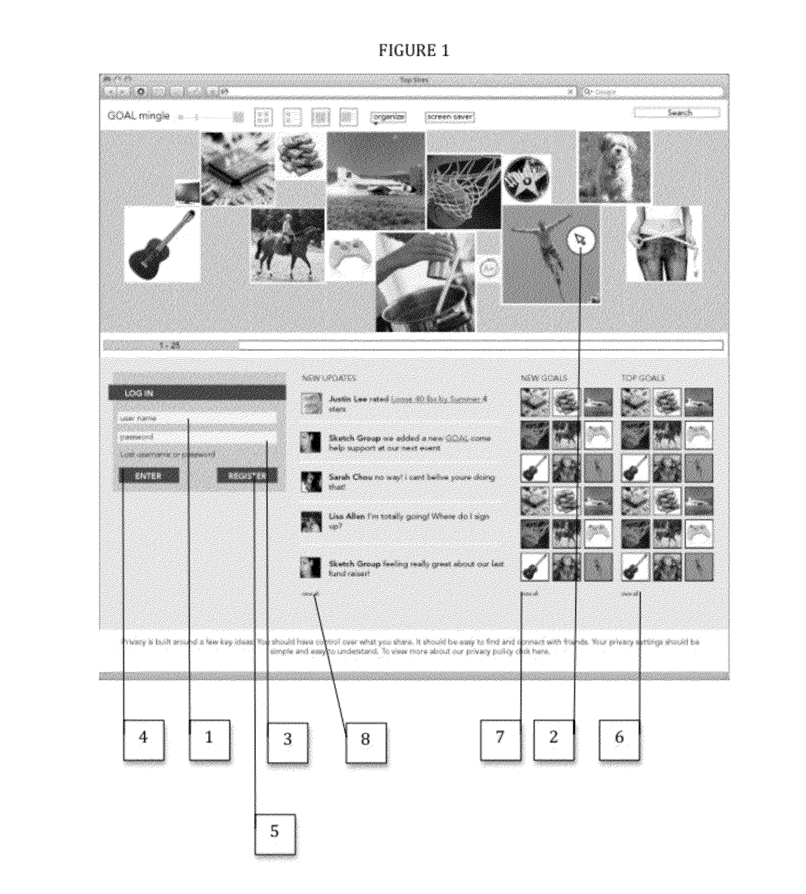

Upon entering through the graphical user interface (“GUI”), the user will first see the a representation of a home page. Please reference FIG. 1. This area will allow the user to log in by entering 4 their user name 1 and password 3 or they can register 5 for the system. The user will be able to see a list of constantly refreshed message posts and goal updates by random users selected by the system. If they wish to see a whole page of this they can by clicking 8. The system will also select and show New Goals at random which the user can see a whole page of by clicking 7 and Top Goals by clicking 6 which is also selected at random by the system. Featured goals are shown and can be selected to view its goal page at the top of the page 2. These goals are also selected by the system by goals that have a lot of activity or if a goal wants to sponsor/donate money they can be added to this selection.

### 2. Goal Images Area

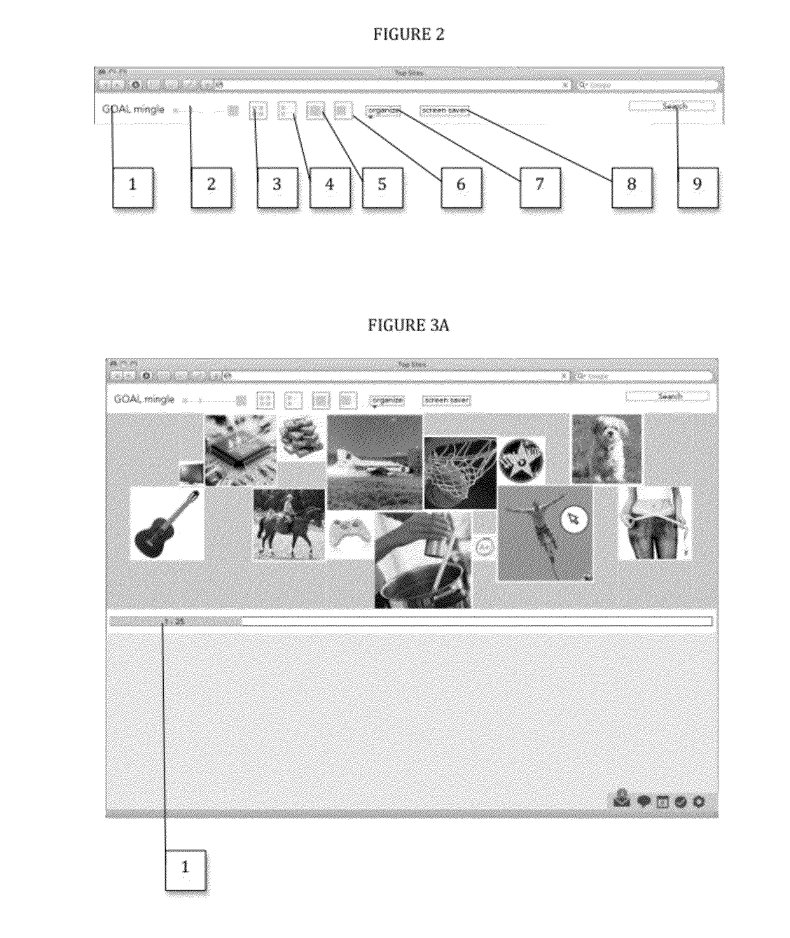

Please reference FIG. 2. If the user is logged in the top images area will show the users personal goal images from the goals they joined and/or created. The user can control the way the images are shown/organized from the options at the top.

1. User can always go to the system home 1.

2. Change size of thumbnails (larger or smaller) 2.

3. Selecting 3 shows default thumbnail view shown in FIG. 1. Size of the images depends on users activity % of the goal. Activity % is the amount of To-Dos completed by the user compared to the total amount of To-Dos for that goal.

4. Selecting 4 allows user to view goal images as a list of thumbnails with small detail containing goal name, % completed based upon how many To-Do's total and completed, and users rating based on 5 star possible rating given by user after each task is completed (system will average all star rating and show overall goal star rating) 5. View goal images all at the same size as large thumbnails by selecting 5.

6. Selecting 6 allows user to view goal images as large thumbnails with detail of goal containing goal name, % completed, user rating, users current active To-Dos of that goal, and link to goals master page to view more.

7. Drop down menu 7 allows user to organize the thumbnails by random, completion % of goals To-Do list, and date goal was started/completed.

8. Screen saver 8 will take thumbnail images of the users goal and put up a screen saver.

9. Search bar 9 is to search all of the system. User can type any keywords (user names, events, activities . . . etc.). System will try to complete users search as they are typing. User can select what system is trying to complete or if the system isn't correctly finding what user is trying to search for, a search page will be brought up with more findings containing users keywords.

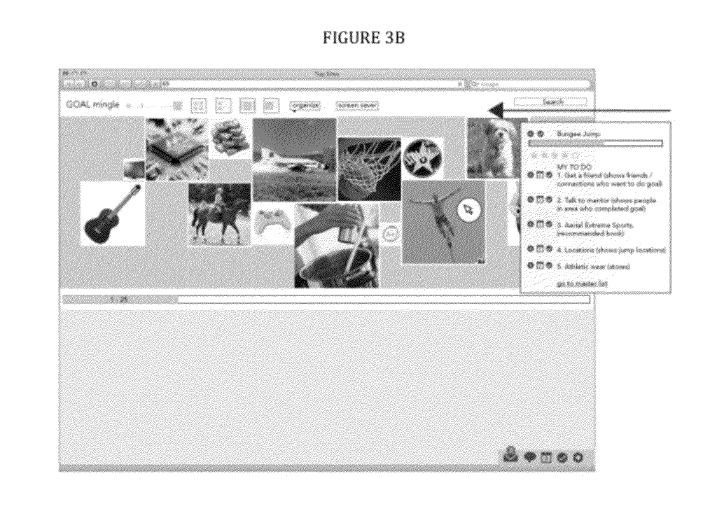

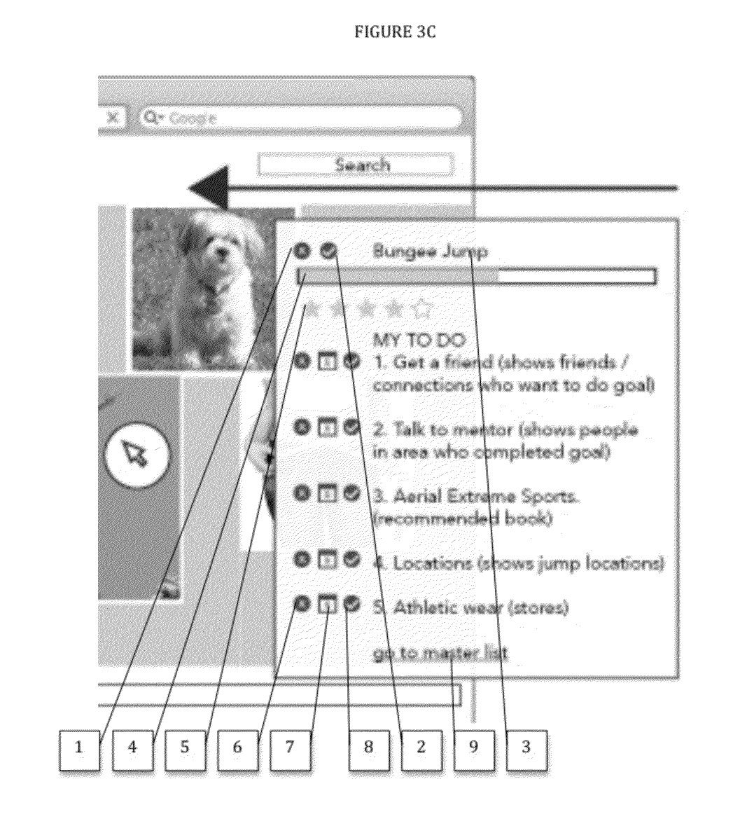

Users can look through their goal images through 1 illustrated in FIG. 3A. The user can hover over a goal image to see the goal name and % of goal completed, or mouse click on a goal image, which allows a user to access quick information about that specific goal. If user clicks on a goal image a box slides out on top of goal images FIGS. 3B and 3C. The box will allow the user to access a few options for that specific goal right from any page if logged in. In this example, FIGS. 3B and 3C illustrate a user who has clicked bungee jumping and his personal list slides out on top showing brief summary of the status of his goal. From this box the user can do the following:

1. User can delete goal.

2. Mark goal as complete 2.

3. View name of goal 3.

4. View current completion of goal based on users completed and created To-Dos of goal 4.

5. View overall current rating of goal based on users rating of each completed To-Do 5.

6. Delete a To-Do from the list 6.

7. Add time/date limit of a To-Do (which will be seen on the users calendar)

8. Mark a To-Do as complete 8 (and then user will give rating of that To-Do to which system will average all To-Do ratings for the overall current rating of goal.)

9. Go to Master List of goal 9. On that goals page user can add, remove or edit To-Do's on their Master List, view current events, or edit calendar.

### 3. Registration Step 1

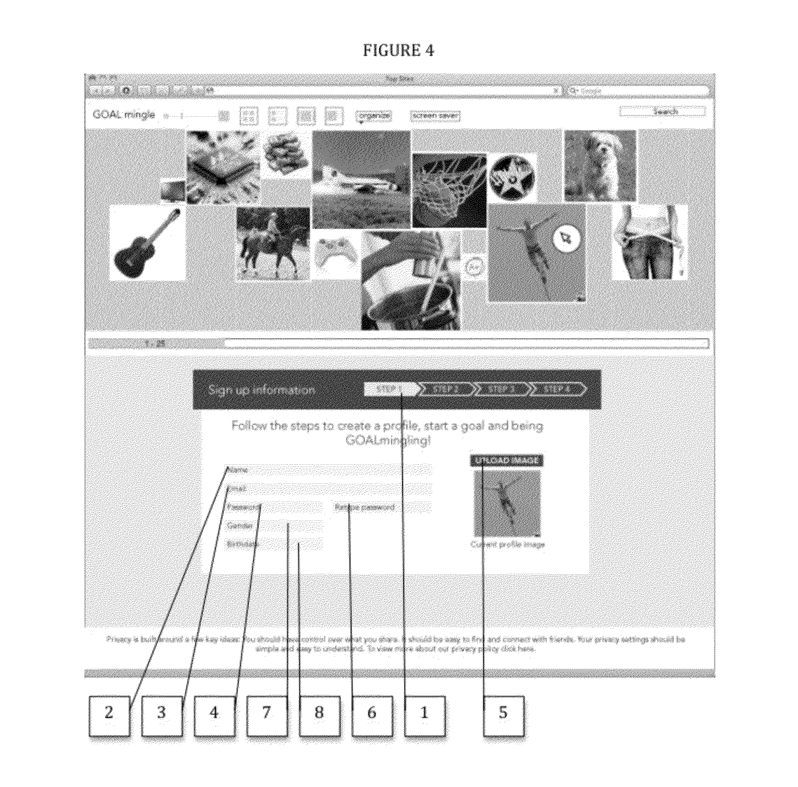

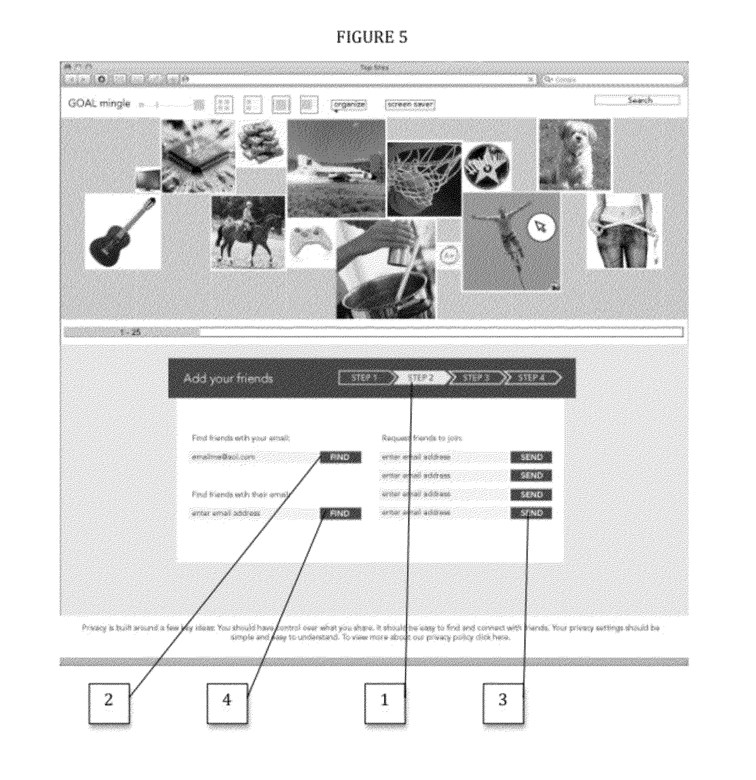

A simple registration process allows user to enter personal information and interests. This will allow the system to use the information to better target users for goals and friends. Also this will allow for marketing data to be collected about the kinds of users, their locations and their interests. Once the user enters information and registration is complete, the user can start obtaining goals, which is shown on the START GOAL page after registration. First the user will have to enter the following standard information FIG. 4:

1. User enters full name 2.

2. Email address 3.

3. Password 4 and re-type password 6.

4. Upload user image 5.

5. Gender 7.

6. Birthday 8.

And when all the information fields have been filled 1 will change state to be noticed and become clickable.

### 4. Registration Step 2

User will be able to find friends and request friends to join FIG. 5.

1. Find friends with your email 2. User can enter in their email address to connect to their email's address book and system will notify user which friends in their address book have the system by searching for registered users with their address books information. User can then connect to friends by telling the system which friends to befriend and system will send them a friend request.

2. Search for friends by entering their email address 4. System will bring up the friend with that email and user can send them a friend request. If that email address/friend isn't on a member or registered user of the system then the system will send them a request to join.

3. Request friends to join by entering in their email address 3 and system will send them an email asking them to join and befriend user.

User can then move onto step 3 1.

### 5. Registration Step 3

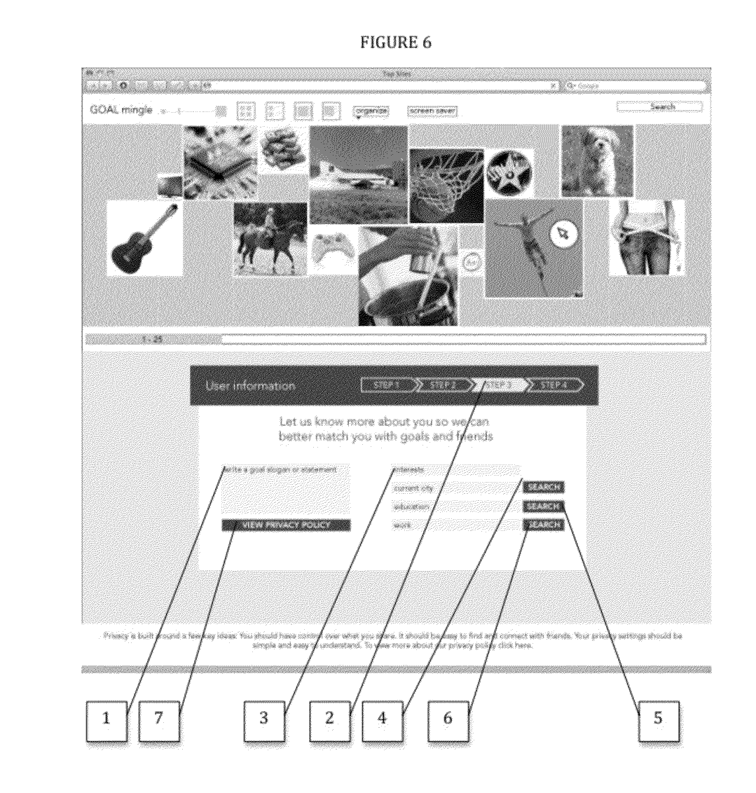

Entering this information will allow the system to use and link the key words to suggest goals and friends more precisely FIG. 6.

1. User will write a short goal slogan or statement 1. System can link key words in the statement to other users to suggest other friends of similar interests.

2. Entering interests 3 will allow the system to use key words to suggest similar goals and friends users could be interested in.

3. Current city will allow system to find friends, goals, and events in users area. This will also allow system to suggest stores and locations to user so they can complete their personalized To-Dos in order to finish goals and accomplishments. User can type in their city in the type box or find it by clicking the search button 4.

4. Education will allow system to link friends and goals to user by using key words. User can enter in their education information or they can click the search 5 button to find them in our database if it has already been used by another user.

5. Work experience will allow system to link friends and goals to user by using key words. User can enter in work history information or click search 6 to find them in our database if another user has already used it in their profile information.

6. User can also view entire privacy policy 7 and then move onto step 4 2.

### 6. Registration Step 4

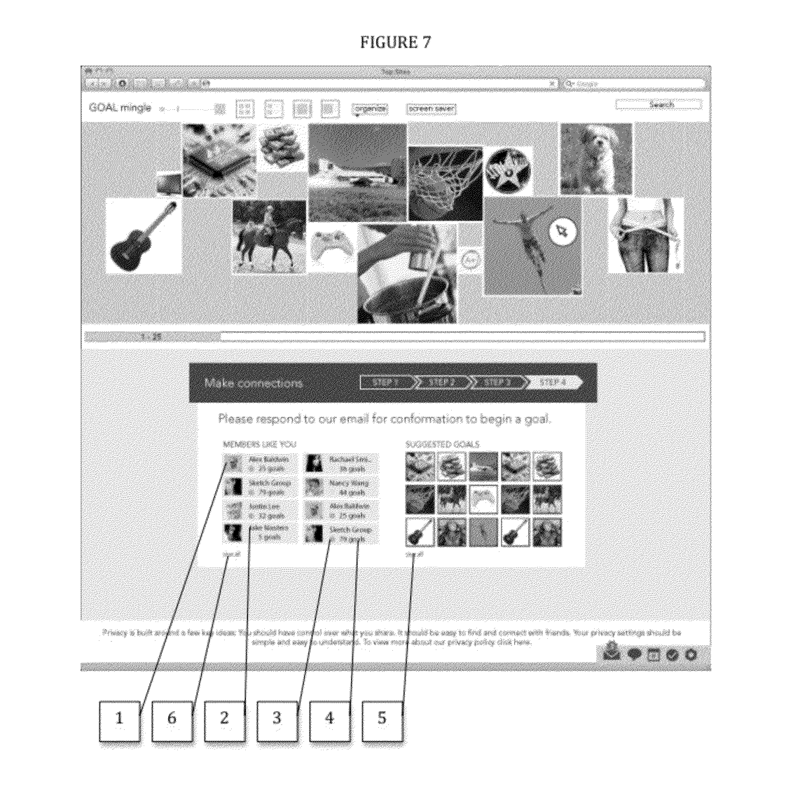

The last step of registration is an email will be sent to the user for conformation. A link inside the email will take them to the START A GOAL page where they can start and customize their first goals. On the final step page FIG. 7 the user will see that they need to answer an email and also be able to view the following:

1. The system will suggest members like the user based on similar information entered in from the registration process and their profiles. Members here are shown with their profile image 1, name 2, online status 3 (red offline, yellow idle, green active online), and view how many goals they have 4. User can view more members 6 or click on a member and view their page but can only befriend them after confirming the email.

2. The system will also suggest goals for the user from users interests and other information entered by the user from the registration process and on their profile. User can view more suggested goals 6 or click a goal image to view the goal page and goals master page.

### 7. Toolbox

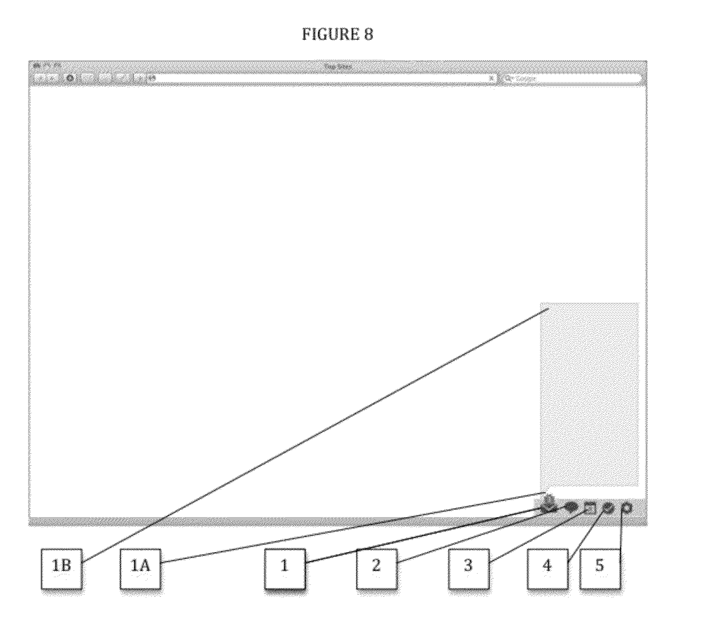

Once a user is registered and logs into the system they will be able to have a toolbox at the bottom of every screen which will allows them to access certain information quickly. Reference FIG. 8. User can access their mail 1, chat with users online 2, go to their calendar 3, go to their master To-Do list 4, or go to their administrator options. Alerts will show above the mentioned buttons 1A with the amount of new alerts for that button. The button can be clicked and small pop up menu will show 18 briefly listing the new alerts. Mail 1 alert refers to the users new emails or comment alerts and list them in the pop up if icon is clicked, chat 2 alert will show how many of the users friends are online and if clicked list them in the pop up, calendar 3 alert will show how many calendar events are due current day and if clicked list them in the pop up, Master List 4 alert shows how many To-Dos are pending for the day and if the icon is clicked a list above the icon will pop up. If the user clicks any link from the pop up it will re direct them to that page.

### 8. Personal User Page

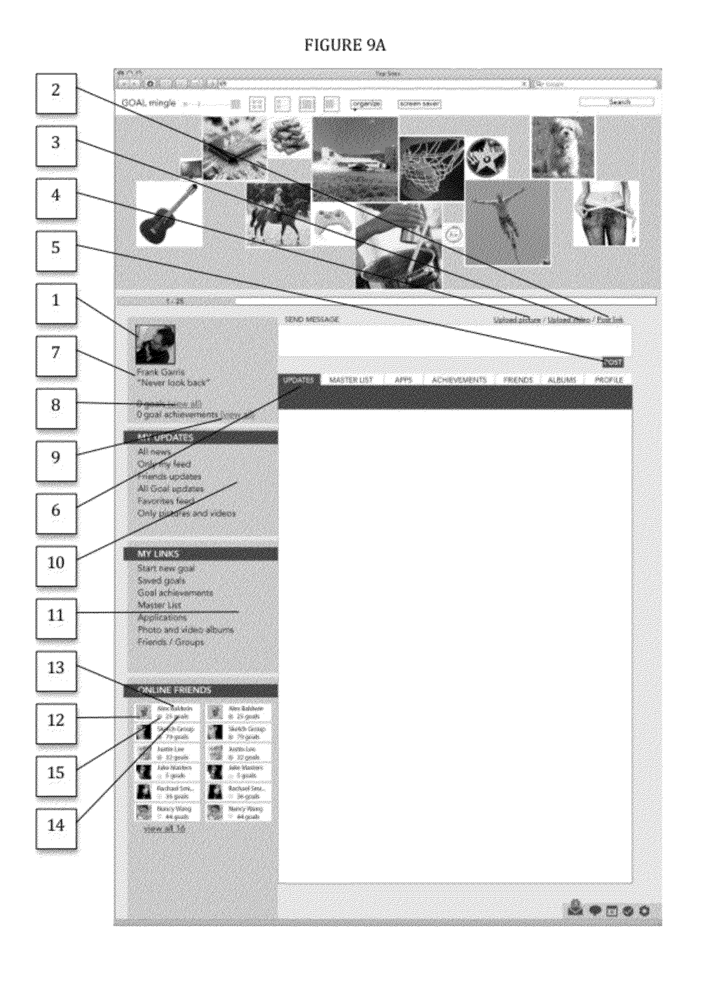

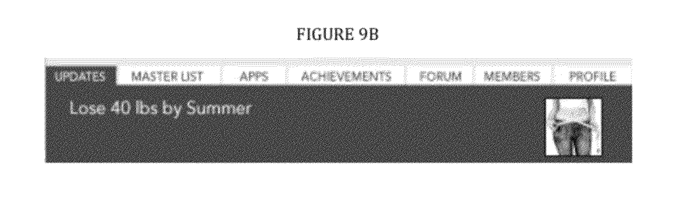

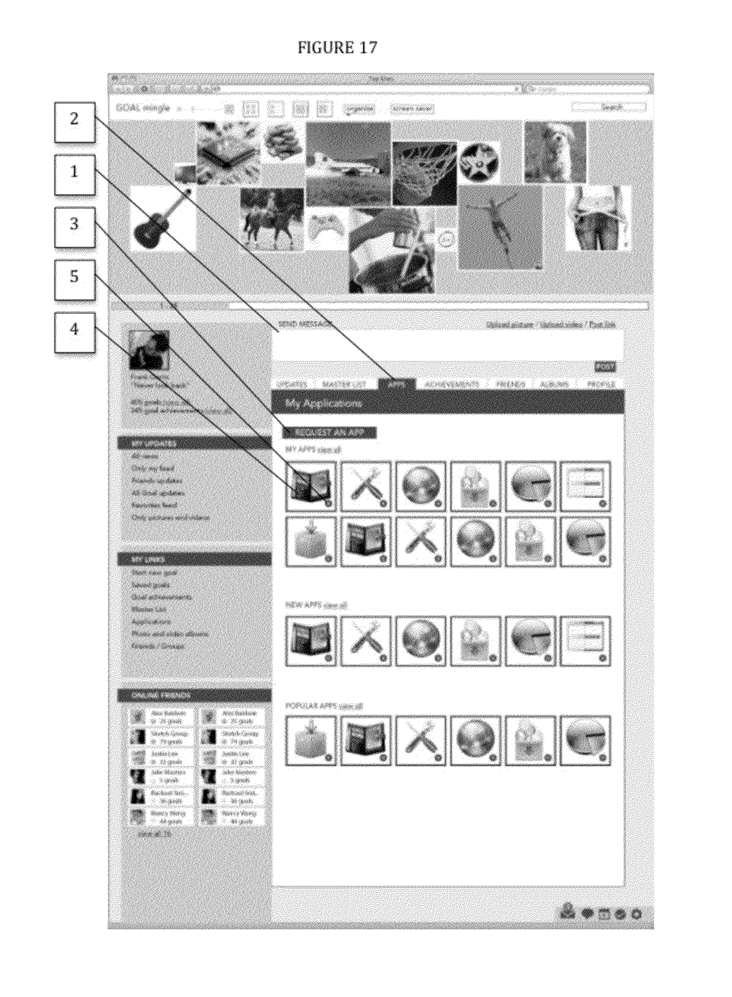

If the user is logged in on the left side of every page there is a user column as illustrated in FIG. 9A. Displayed is the users profile picture 1, name and goal statement 7 which was entered in when the user registered, how many goals the user has and a link to view all 8, amount of goal achievements given by completing certain goal tasks and a link to view all 9 (clicking this will take them to the users Achievements page, please see FIG. 17).

Under My Updates 10, illustrated in detail in FIG. 9B, the user can organize the information in their Updates tab 6 by all news, only their posts/feed, friends updates, all goal updates, favorites feed where only their favorite marked users and goals will show, or only pictures and videos. The tabs will vary slightly when user is on a Goal page as illustrated in FIG. 9A.

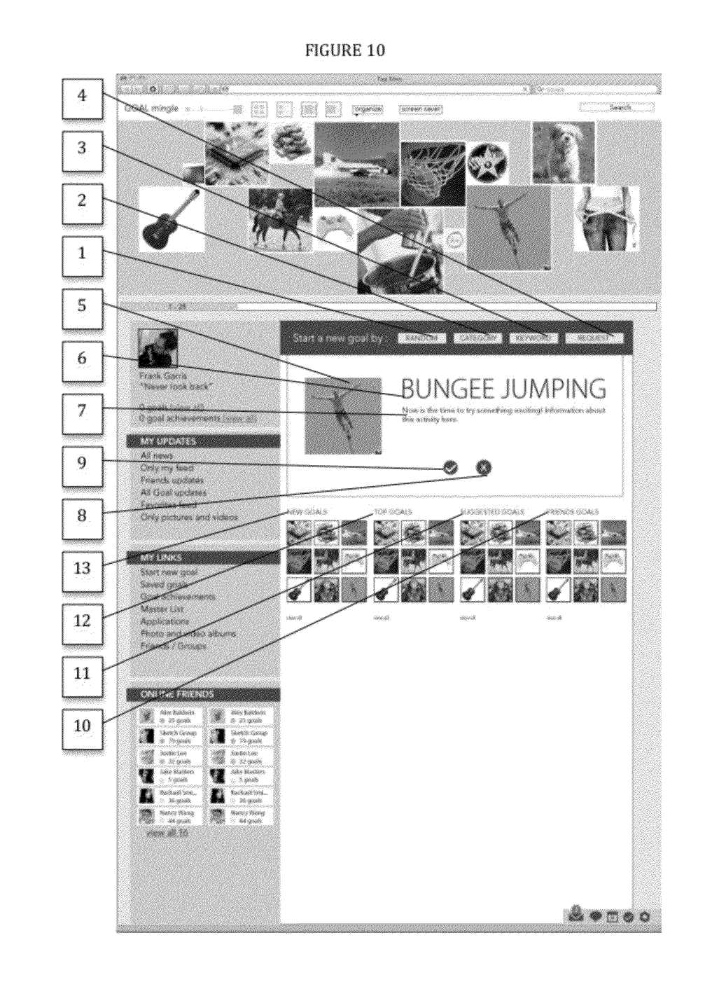

My Links 11 and Online Friends 12 will be consistent on every page. Under My Links 11 the user can start new goal and be directed to the start a goal page (see Start a Goal Page FIG. 10), if user saved goals to start at a later time they can view them in the saved goals button, view their goal achievements page, Master List page, applications page, photo and video albums, and their friends and groups.

Under Online Friends user can see the status of their online friends. User image of the friend is shown 12, the user's name 13, how many goals they have active 14, and their activity status 15 green meaning active and yellow meaning idle. There is also an area where people can leave a message onto a user or goals page and it will show on the Updates Tab for Personal pages 6 and the Updates Tab for Goal pages as illustrated in FIG. 9A. In sending a message user can also upload a picture, video or post a link

### 9. Start a Goal Page

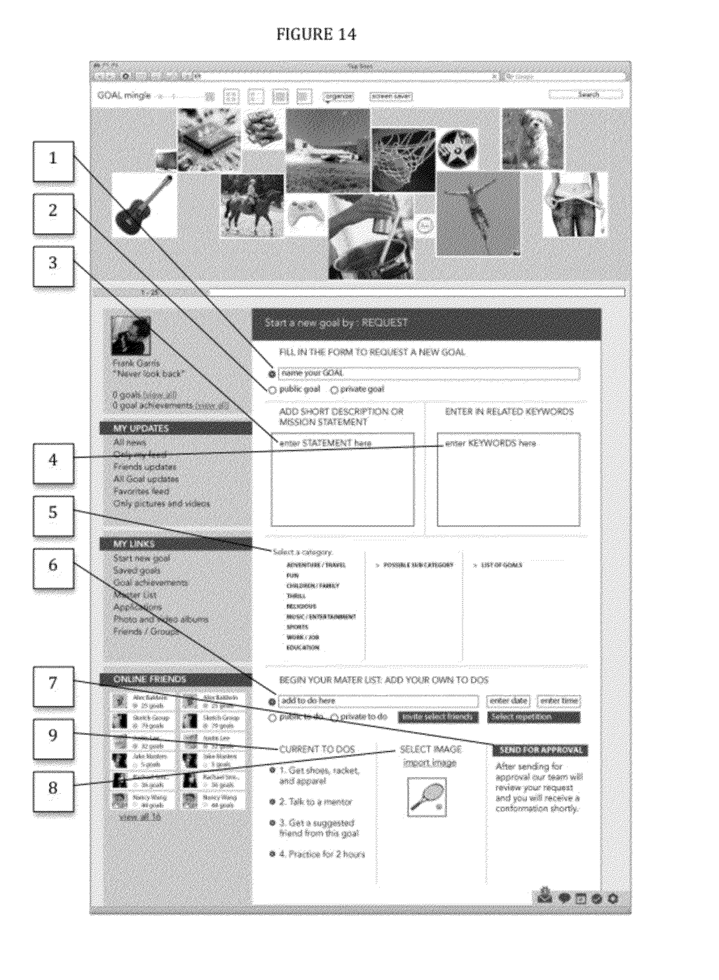

After completing the registration process the user will log in and see the Start a Goal page FIG. 10 only the first time they log in. After they will log in and see their personal page Updates tab (FIG. 14A) upon log in. The Start a Goal page can also be accessed from the Start a Goal button FIG. 9A 11. This page will allow the user options upon selecting their first and future goals.

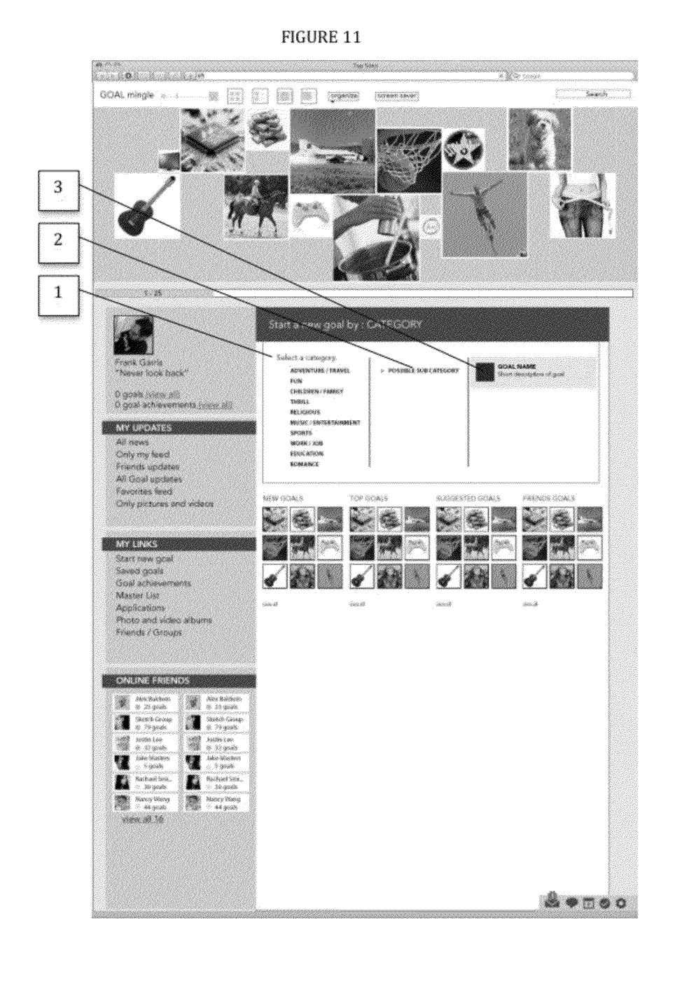

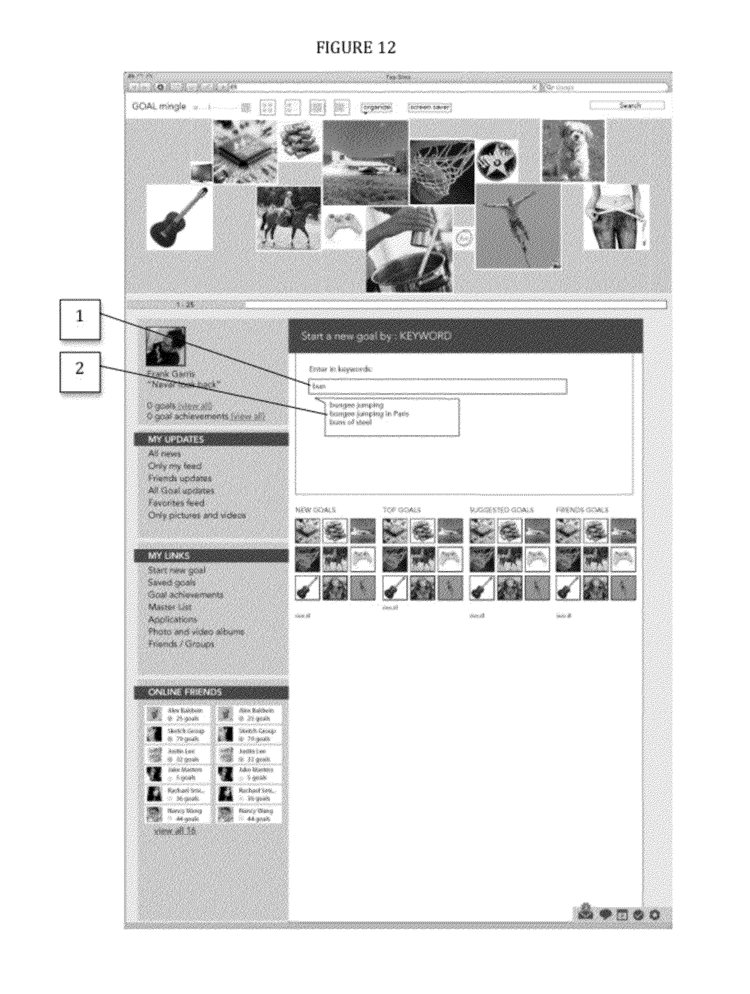

The user can choose a goal by random 1 (shown in FIG. 10), by category 2 (FIG. 11), keyword 3 (FIG. 12) or request a goal 4 (FIG. 14). At the bottom the user will see new goals 13, top goals by rating 12, suggested goals to the user by the system from information the user put in the registration process 11, and friends latest goals 10.

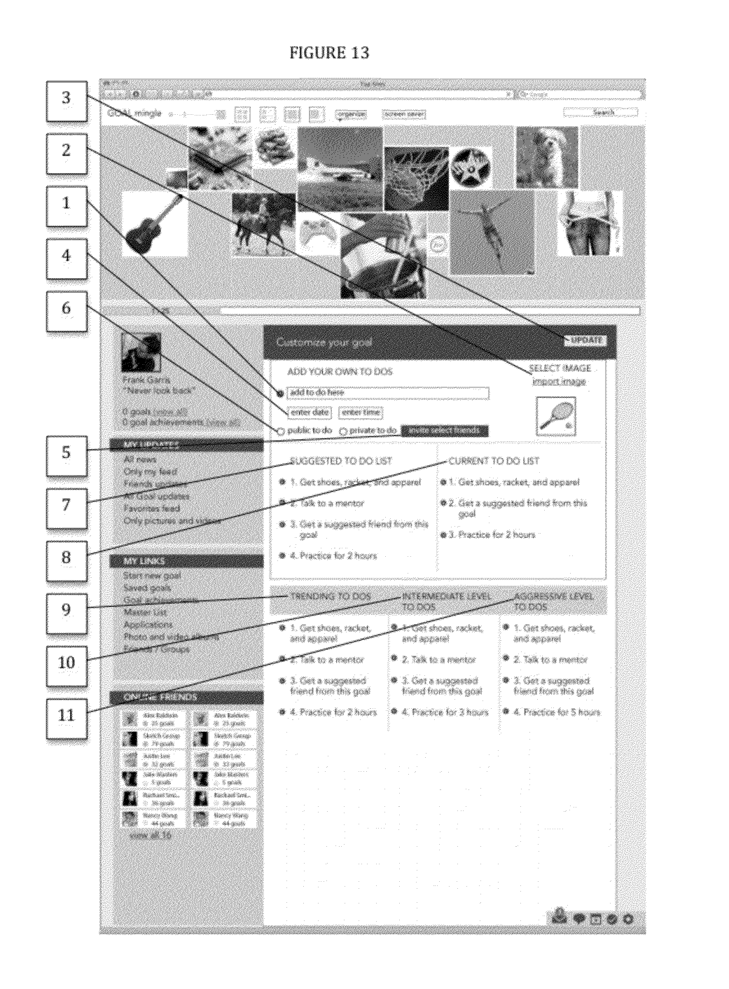

In the random goal page a random goal will already be on the screen with its profile picture 5, goal title 6, and a short description 7. User can close the goals and a new one will replace it or the user can select the current goal 9 and be taken to the goal master page set up window (see FIG. 13).

### 10. Start a Goal by Category

If user selects the Category button 1 as illustrated in FIG. 11 they will be able to choose goals out of a specific category. Listed are the main groups of categories 2 such as adventure, sports, romance etc. If necessary the user will then be given a list of sub categories 3 to narrow down the search or a list of goals or a list of goals 4 with a small profile picture of the goal, goal name, and a short description. If the user selects one of these goals they will see the Edit Goal page (see FIG. 13) to customize their Master List and begin their goal.

### 11. Start a Goal by Keyword

If user selects the Keyword button 1 as illustrated in FIG. 12 they will be able to start typing 2 in keywords and as the user is typing a list below will pop up 3 of actual goals already created and user can select one of them to begin and they will see the Edit Goal page (see FIG. 13) to customize their Master List and begin their goal.

### 12. Edit Selected Goal

If a goal is chosen from the start a goal page that has already been created, the user will be able to customize its To-Do list to fit their personal needs (see FIG. 13). Already created goals have a suggested To-Do list 2 made by the creator when the creator made their Master List for this goal. This list is to help a first time user of this goal see possible To-Do's they wouldn't think of to aid them in goal completion. The more users of the goal the better the list that gets generated by the system. This is because the system over time will show the most used To-Dos of that goal and suggest them to subsequent users of the system. Eventually the system will have so much data it will be able to suggest To-Dos even to the point of what is best for most women or men and even for age group.

The user can add a To-Do from the Master List 2 and/or they can add their own 1. If the user is adding their own To-Do the system will suggest other To-Do's with the same key words so the user will not duplicate To-Do's that have already been created by other users. Either way, once they add a To-Do they can put a due date 4 on it by adding it to their calendar (this can be seen on their personal Master List and also when they visit that goal page and view Master List). User can also change their mind and delete 5 the To-Do from this list. Finally they will choose a picture for this goal that will replace the default created one to finish the personalization.

### 13. Request a Goal

If the user wants to start a goal that has not been created yet they may request a goal for approval (see FIG. 14). The user fills out basic information about the goal so that the system can regulate goals and make sure no one is starting any goals that are inappropriate. User will enter in a brief goal description 1, assign it to a general category from a drop down list 4, add interests 6, of the goal so the system can track its key words and suggest it to similar goal members, start to create a Master List 2 of To-Do's or remove them 3, add a picture 5, and submit it to the system 7.

### 14. User Page—Updates Tab

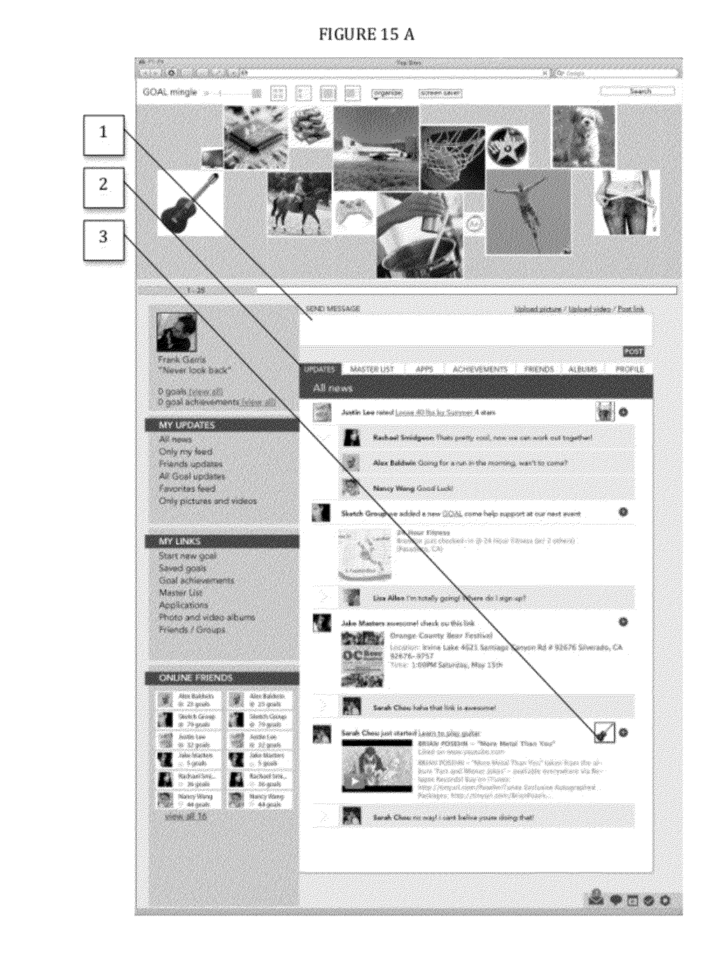

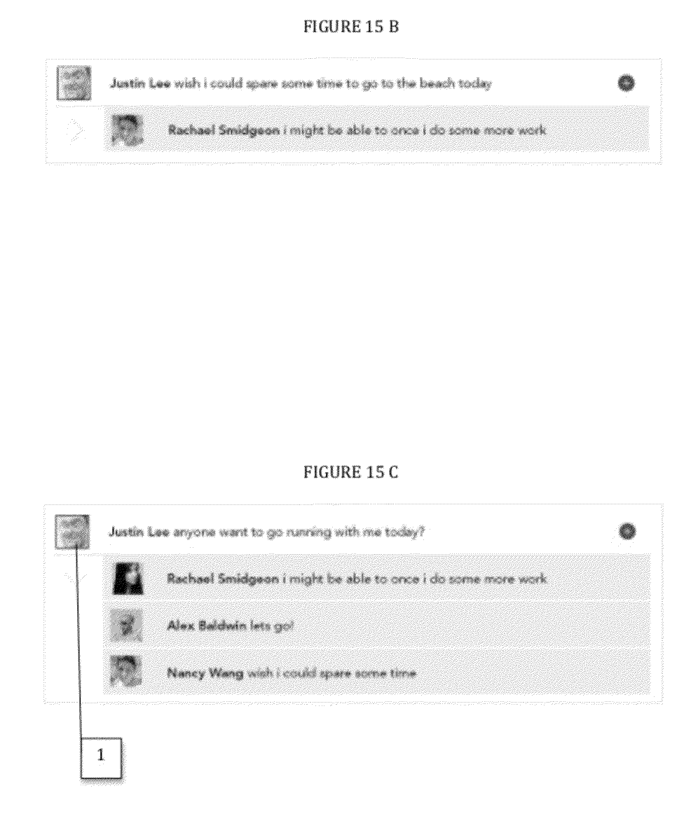

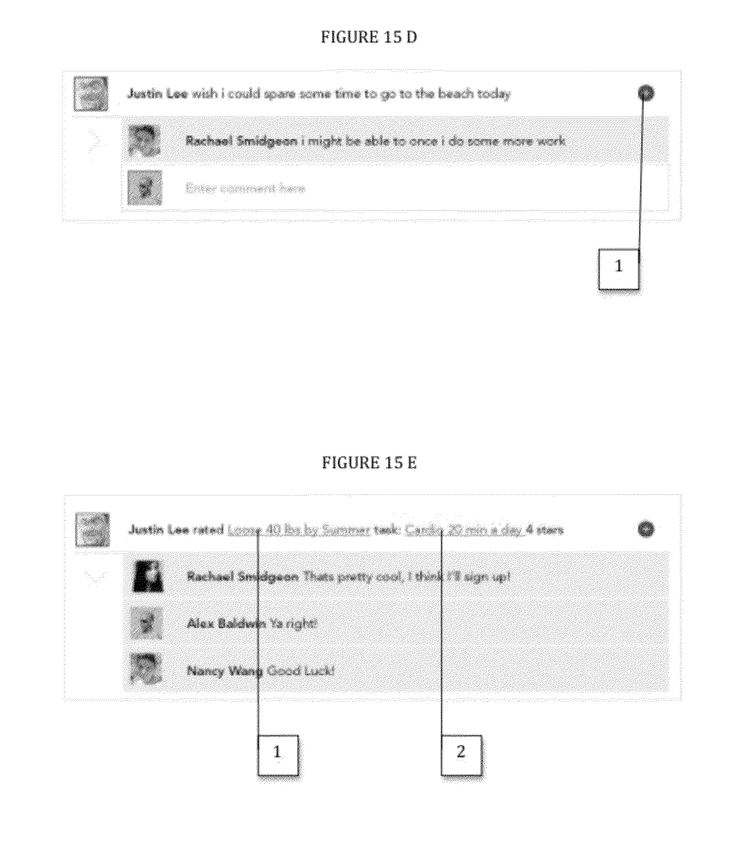

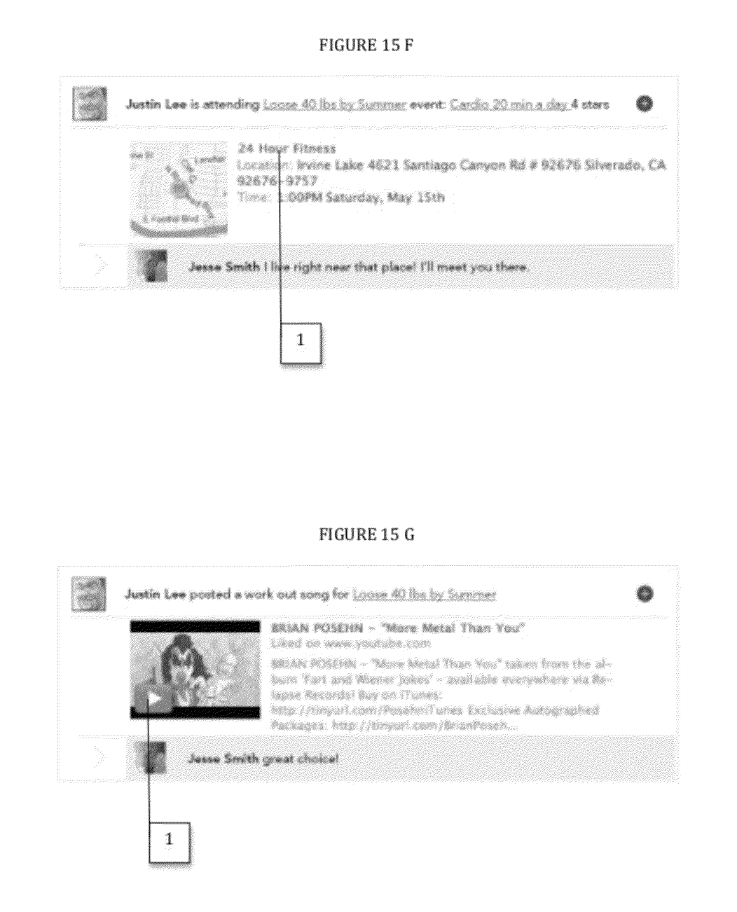

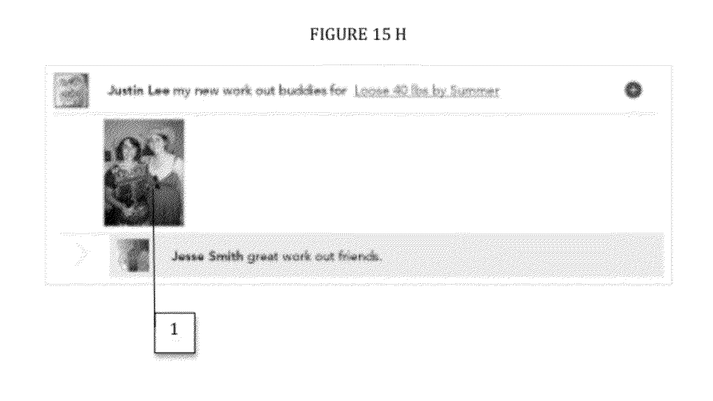

Once user logs in and completes the registration and has already started at least one goal the user will log in and see their USER PAGE—UPDATES TAB 2 as illustrated in FIG. 15A. If the user is on their own or a friends USER PAGE TABS messages posted 1 here will be seen by other friends in their friends USER PAGE—UPDATES TAB, and in the users own USER PAGE—UPDATES TAB. If the user is visiting on another persons page and they are not friends they will not be able to send a message onto the UPDATES TAB. They will have to be added as a friend or if the user allows strangers to send a personal message they can send a personal message.

User will be able to post text FIG. 15B and pictures FIG. 15H, videos and links FIG. 15G, and events FIG. 15F. Also, whenever the user does or completes something goal related the system automatically posts this onto the USER PAGE UPDATES TAB. An example of this is FIG. 15E where user Justin Lee rated the task of “Cardio 20 min a day” for the goal “Loose 40 lbs by Summer” and rated it with four stars. The user can click this link 1 and it will take them to that GOAL PAGE where they can start it or view its page or if the user already has that goal they can click 2 to add this to their Master List of the goal.

Users can comment on anything posted. If there are one or more comments on a post the newest comment will be shown FIG. 15B. If the user wants to see more comments the user can click the arrow to drop down all the comments 1 as illustrated in FIG. 15C. If the user wishes to post a comment they can by clicking 1 as illustrated in FIG. 15D and a comment area box will show. Posting an event FIG. 15F will allow the user to click on the link title 1 and it will bring up the event on its own page showing who is attending and more detailed information. Posting a video FIG. 15G will allow the user to click 1 and the video will pop up playing the video. Pictures can be posted FIG. 15H. They can be clicked to show the picture large on its own page with all the comments from the album the picture was posted to.

### 15. User Page—Master List Tab

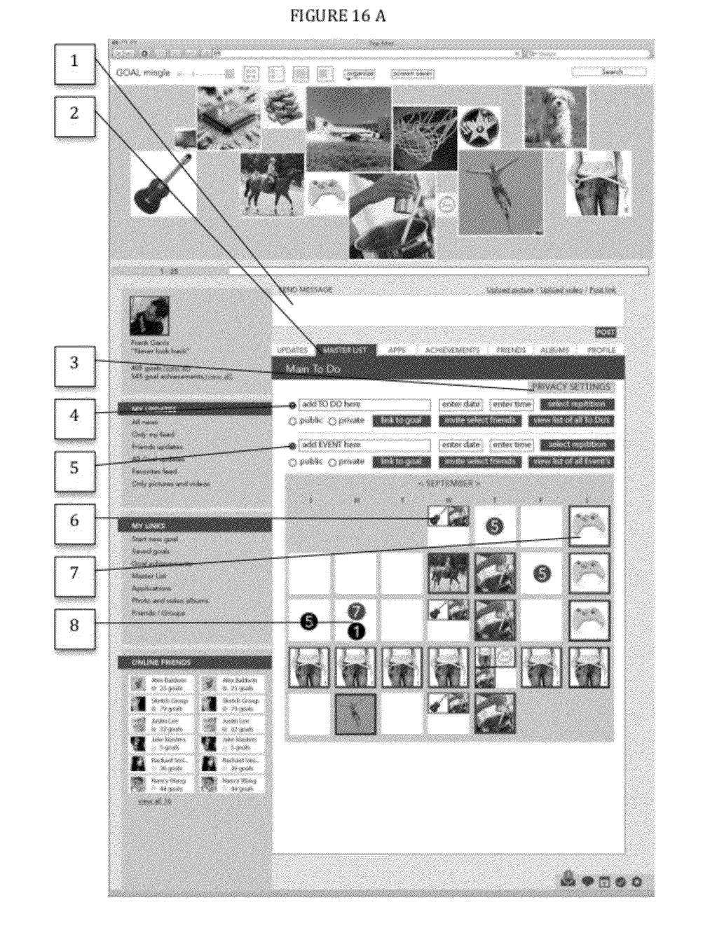

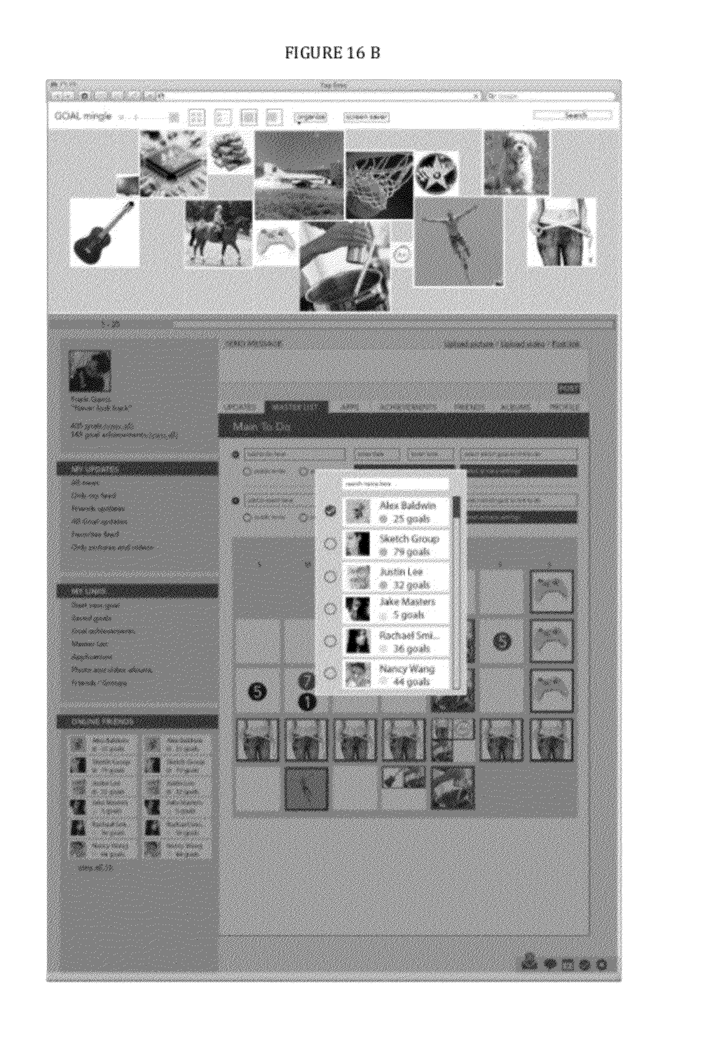

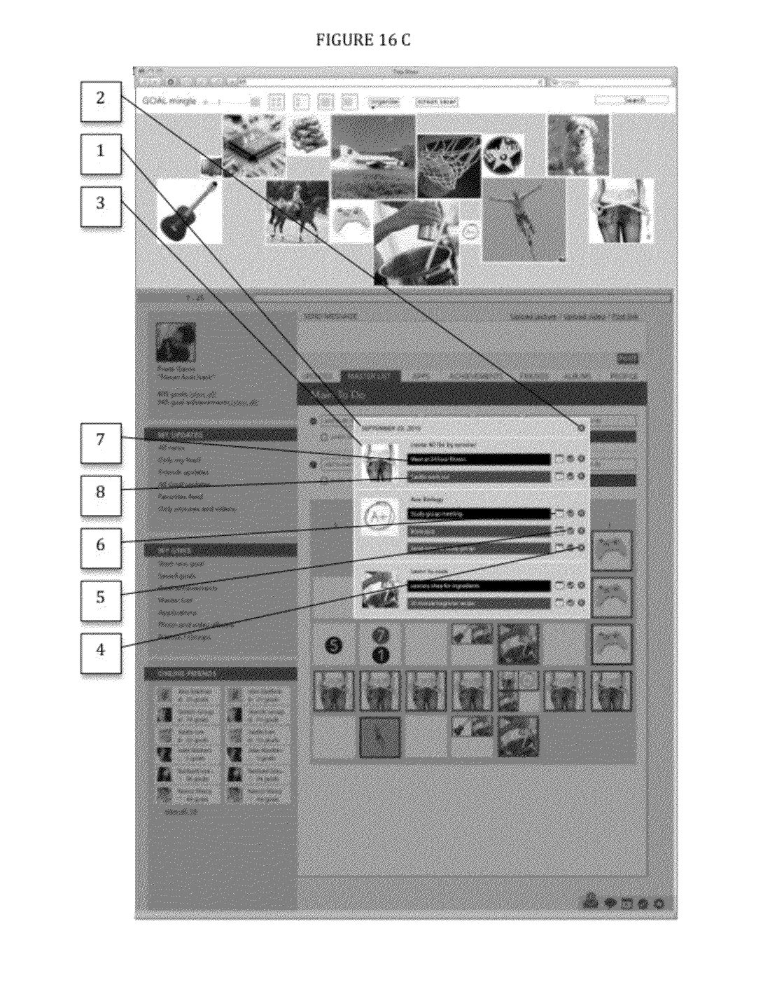

This feature is illustrated in FIG. 16A. All calendar events and To-Do's are here in the MASTER LIST 2 tab. User can click to view and edit all goal specific To-Do's and Events. User can customize To-Do's and Events to also include friends and/or goal members (see FIG. 16B).

If the user is on their own or a friends USER PAGE TABS messages posted 1 here will be seen by other friends in their friends USER PAGE—UPDATES TAB, and in the users own USER PAGE—UPDATES TAB. If the user is visiting on another person's page and they are not friends they will not be able to send a message onto the UPDATES TAB. They will have to be added as a friend or if the user allows strangers to send a personal message they can send a personal message.

User can add any To-Do 3 or Event 4 and be able to link it to a goal. The To-Do and/or the Event can be seen from this tab or on the specific goal page Master List. All To-Do's will have a teal border around the image or a teal circle with amount of To-Do's if more than four items are on a specific calendar date. All Events will have a black border around the image or a black circle with amount of Events if more than four items are on a specific calendar date.

If there are more than 4 items on a specific calendar date a number will show with how many tasks are to be completed or events to attend 5. If there are multiple To-Do's and Events that equal to more than for then two numbers will show 7, black referencing To-Do's and black referencing Events. If the image thumbnail or the number is clicked a pop up will show with all the thumbnails of To-Do's and/or Events for that calendar date. This feature is illustrated in FIG. 16C. The date will show 1, an close pop up button 2, the goal image which clicked will take user to that goal page 3, edit To-Do or Event button 6, mark the To-Do or Event as completed 5, and a cancel To-Do or Event button 4. The To-Do 8 or Event 7 can be clicked to view item on a whole page with complete detailed information of To-Do or Event with user, friend and/or member comments and/or pictures, maps, requirements, people attending and more.

### 16. User Page—APPS Tab

The user may collect apps to be in their USER PAGE APPS tab 2 as illustrated in FIG. 17. All apps will be shown here along with new apps and popular apps. Apps will help them achieve certain goals. Clicking an app image 4 will have a pop up window with the app so that they can have multiuse apps running at the same time viewed at the same time. Hovering over the app will show app name and short description. Apps will also have the option of deletion right from the page 5.

If the user is on their own or a friends USER PAGE TABS messages posted 1 here will be seen by other friends in their friends USER PAGE—UPDATES TAB, and in the users own USER PAGE—UPDATES TAB. If the user is visiting on another person's page and they are not friends they will not be able to send a message onto the UPDATES TAB. They will have to be added as a friend or if the user allows strangers to send a personal message they can send a personal message.

If the user has an idea for an app they can request 3 it to be made by the system or another client. By requesting an app we will receive an email of their idea and we can use the information as we like.

### 17. User Page—Achievements Tab

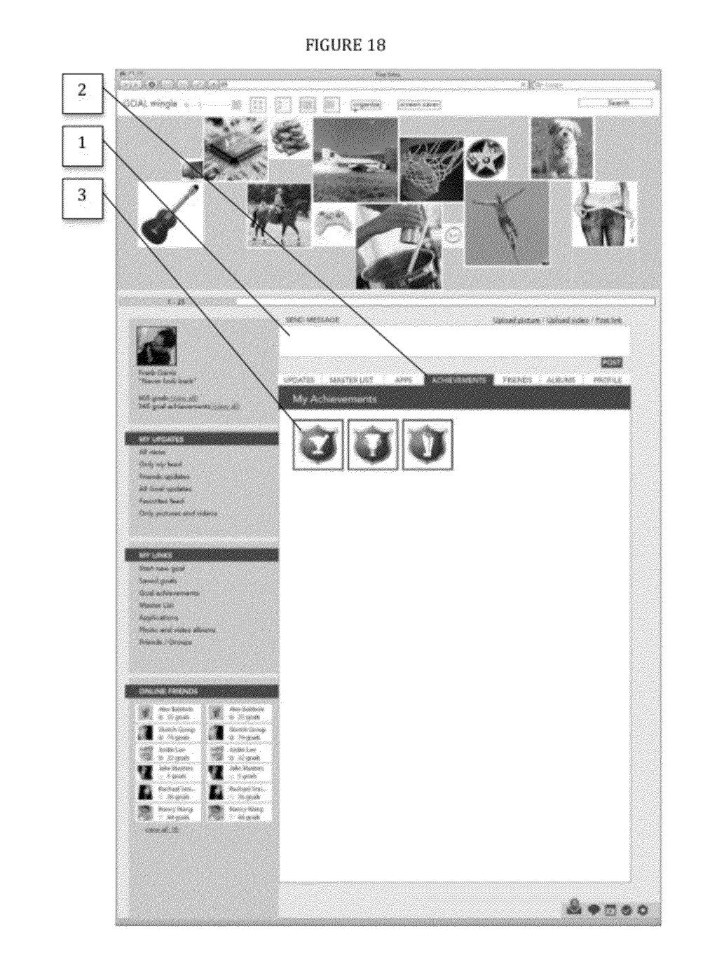

As illustrated in FIG. 18, all awards given to the user by goal presidents/creators are viewed here like trophies or badges 2. Hovering over will say the name of the achievement, the goal name, and a short description. Clicking on the achievement will take the user to that goal page.

If the user is on their own or a friends USER PAGE TABS messages posted 1 here will be seen by other friends in their friends USER PAGE—UPDATES TAB, and in the users own USER PAGE—UPDATES TAB. If the user is visiting on another person's page and they are not friends they will not be able to send a message onto the UPDATES TAB. They will have to be added as a friend or if the user allows strangers to send a personal message they can send a personal message.

### 18. User Page—Friends Tab

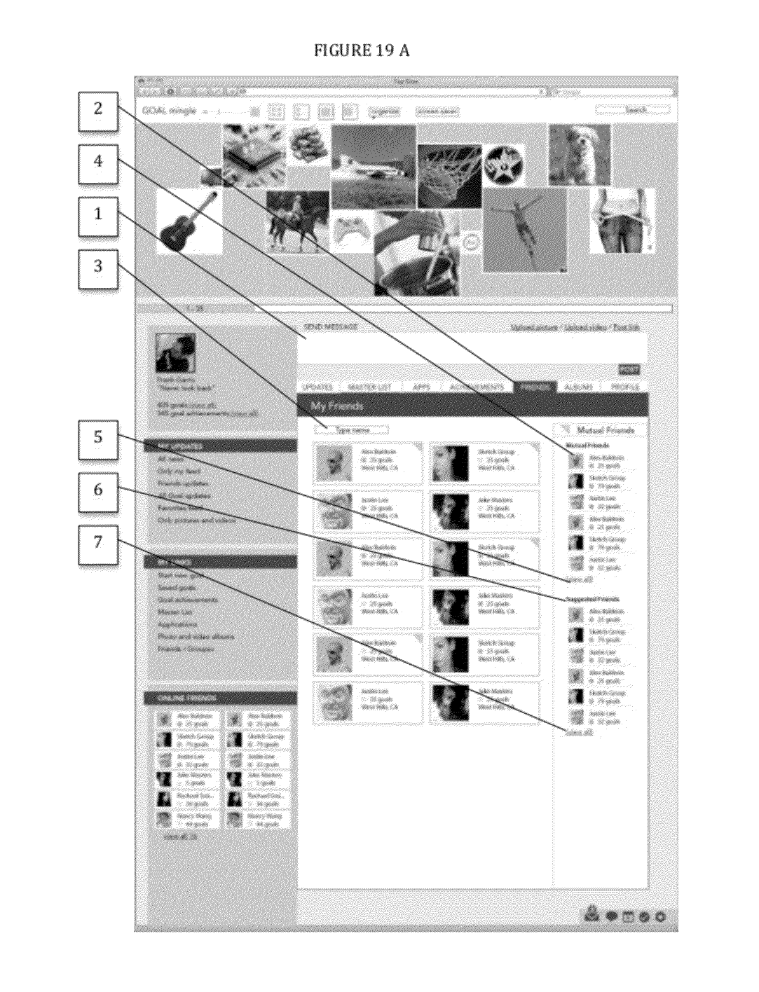

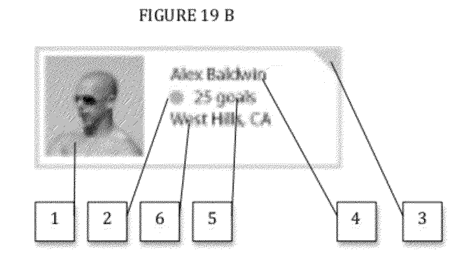

In the USER PAGE—FRIENDS TAB 2, as illustrated in FIG. 19A the user will see their list of all friends and a list of suggested friends 6 by the system who have similar profiles, goal choices, and achievements. If the user is visiting someone else's page there will be another list of mutual friends 4. Mutual friends will also be marked in the general alphabetical list. If the user wants to search this friend page for a particular friend or a friend containing certain letters they can type it in the search bar 3 and a pop up of findings will appear.

If the user is on their own or a friends USER PAGE TABS messages posted 1 here will be seen by other friends in their friends USER PAGE—UPDATES TAB, and in the users own USER PAGE—UPDATES TAB. If the user is visiting on another person's page and they are not friends they will not be able to send a message onto the UPDATES TAB. They will have to be added as a friend or if the user allows strangers to send a personal message they can send a personal message.

There should only be a minimum amount of friends shown in the mutual friends or suggested friends column. If the user wants to view all of the mutual friends 5 or all of the suggested friends 7 the user can do so and it will bring up a pop up list of all the friends. All of the friends are displayed with the following (see FIG. 19B): user profile picture 1, user or group name 4, online status position 2 (green for active online, yellow for idle for more than 10 minutes online, or white for offline), how many active goals the friend has 5, and location 6. If the user is visiting another friends page and the user and friend have another mutual friend there will be a marker 3. If the user clicks a friend image the user will be taken to their user page.

### 19. User Page—Albums Tab

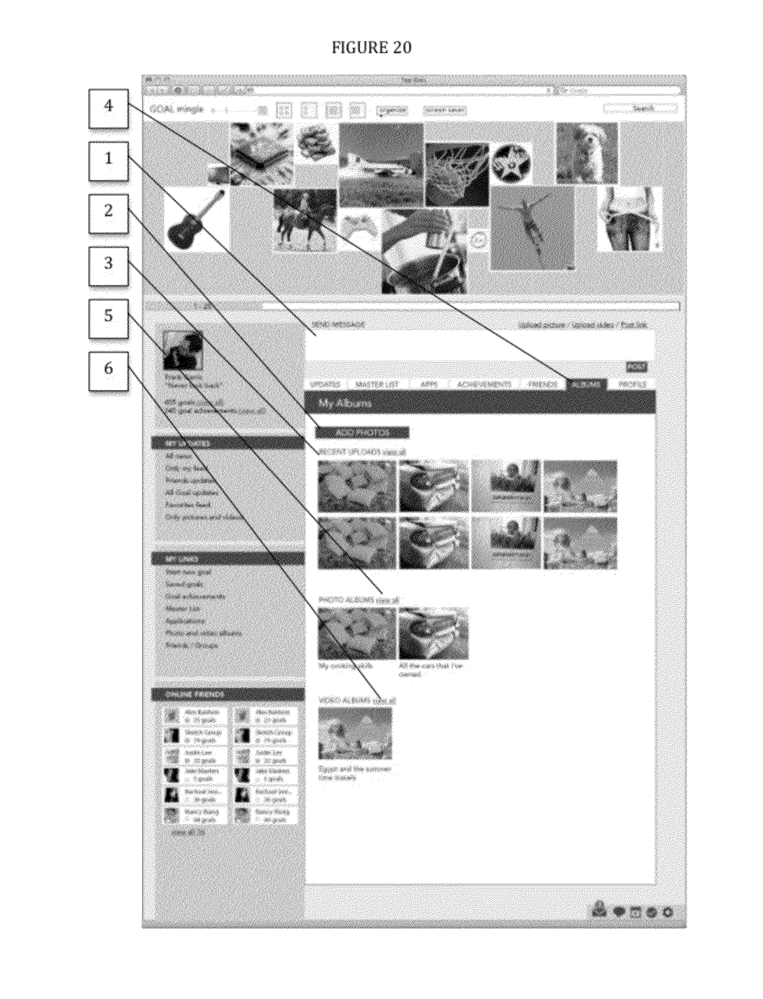

The USER PAGE—ALBUMS TAB 4, as illustrated in FIG. 20 is the area where all of the users photos and videos are arranged. If the user is on their own or a friends USER PAGE TABS messages posted 1 here will be seen by other friends in their friends USER PAGE—UPDATES TAB, and in the users own USER PAGE—UPDATES TAB. If the user is visiting on another persons page and they are not friends they will not be able to send a message onto the UPDATES TAB. They will have to be added as a friend or if the user allows strangers to send a personal message they can send a personal message. The user can add photos to an album 2, see the recently added photos by them and tagged photos of themselves 3, their photo albums 5, and their video albums 6. If any thumbnail is clicked it will show the image large on its own page with the comments posted by users friends and the user.

### 20. User Page—Profile Tab

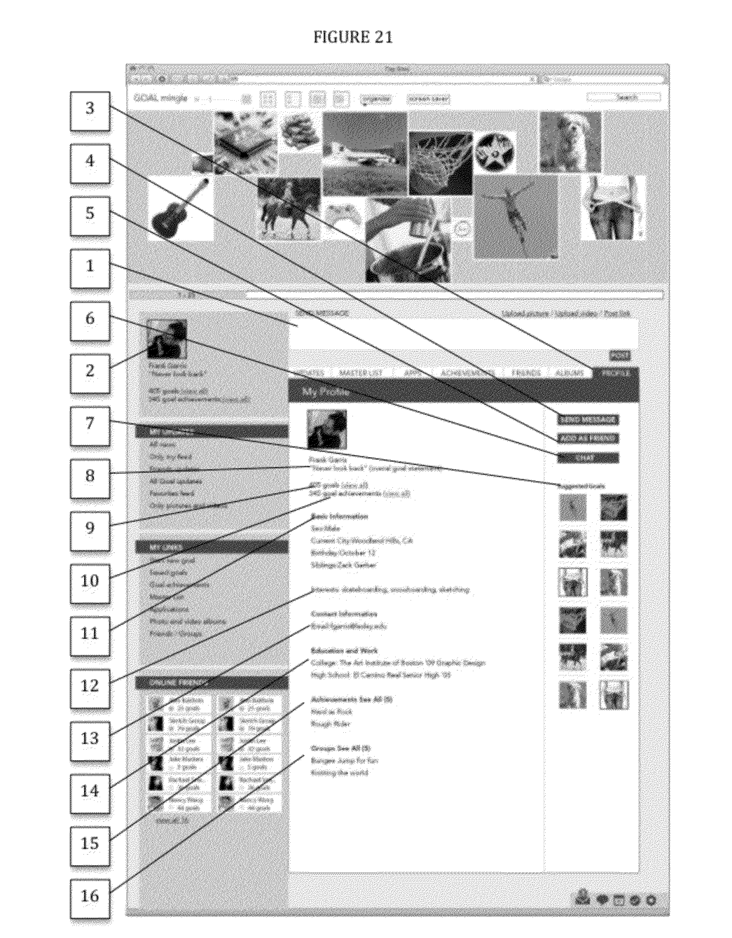

The USER PAGE—PROFILE TAB 3, as illustrated in FIG. 21, contains information about the user and suggested goals based on their profile information entered in at registration. If the user is on their own or a friends USER PAGE TABS messages posted 1 here will be seen by other friends in their friends USER PAGE—UPDATES TAB, and in the users own USER PAGE—UPDATES TAB. If the user is visiting on another persons page and they are not friends they will not be able to send a message onto the UPDATES TAB. They will have to be added as a friend or if the user allows strangers to send a personal message they can send a personal message.

Shown on this page is the user image 2, user name and short goal statement 8, how many goals user has and link to view all alphabetically on one pop up page with a search option 9, users goal achievements and a link to go to their goal achievements tab to view all 10, users basic information entered in at registration 11, users interests entered in at registration 12, users contact information entered in at registration 13, users education and work entered in at registration 14, achievements given to the user by other users admiring their overall accomplishments (non specific goal related achievements can be given to users by users admiring their overall goal accomplishments) 15, and groups the user joined 16, and suggested goals for the user 7. User is signed in on their profile page they can edit any fields of this goal. If the user is visiting another users page they will also be able to send a personal message to the user into a private mail box 4, request to add the user as a friend 6, and if the user is online the chat option will show where they can have a personal chat conversation 7.

### 21. User Page—Mailbox

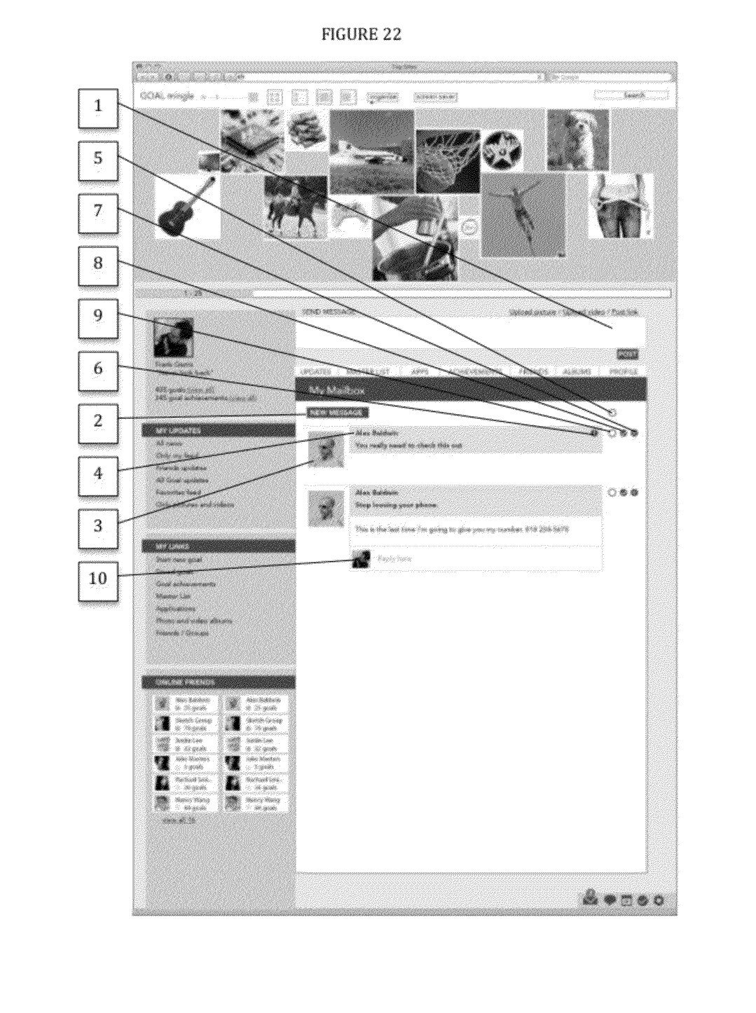

The mailbox illustrated in FIG. 22 can be accessed by clicking the envelope icon in the tool box and when the pop up appears select GO TO MAILBOX. If the user is on their own or a friends USER PAGE TABS messages posted 1 here will be seen by other friends in their friends USER PAGE—UPDATES TAB, and in the users own USER PAGE—UPDATES TAB. If the user is visiting on another person's page and they are not friends they will not be able to send a message onto the UPDATES TAB. They will have to be added as a friend or if the user allows strangers to send a personal message they can send a personal message.

Here the user can write a new private message to a friend 2, see all private messages showing the contact friends user picture 3 and contacts user name and subject title 4. If the message has not been read yet it will have a marker 6, messages can be marked as read by clicking the check mark icon 8, or be deleted by clicking the “x” 7. To select a message 9 can be clicked or to select all messages 5 can be clicked. If multiple messages are selected any of the message options 8 or 7 will apply to the selected messages. If the subject area is clicked 4 the body of the message will appear underneath and the option to reply will be shown 10.

### 22. Goal Page—Updates Tab

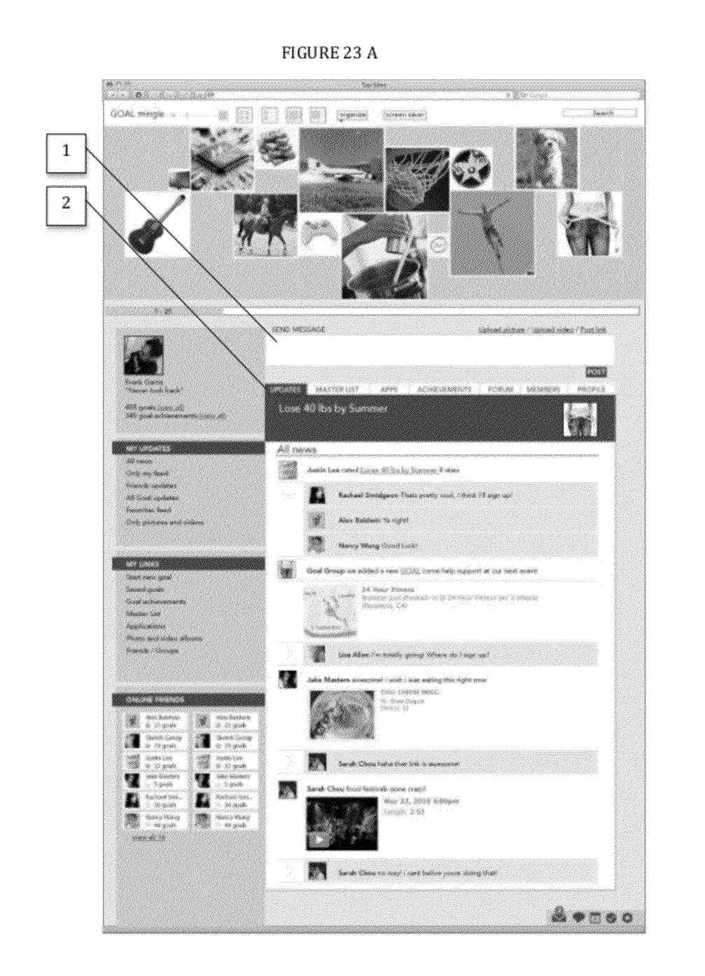

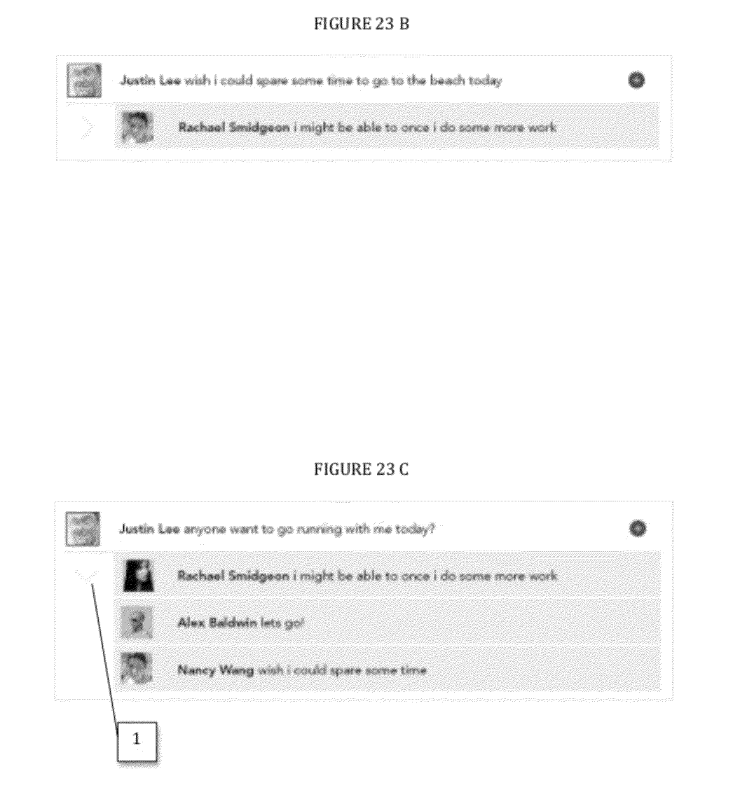

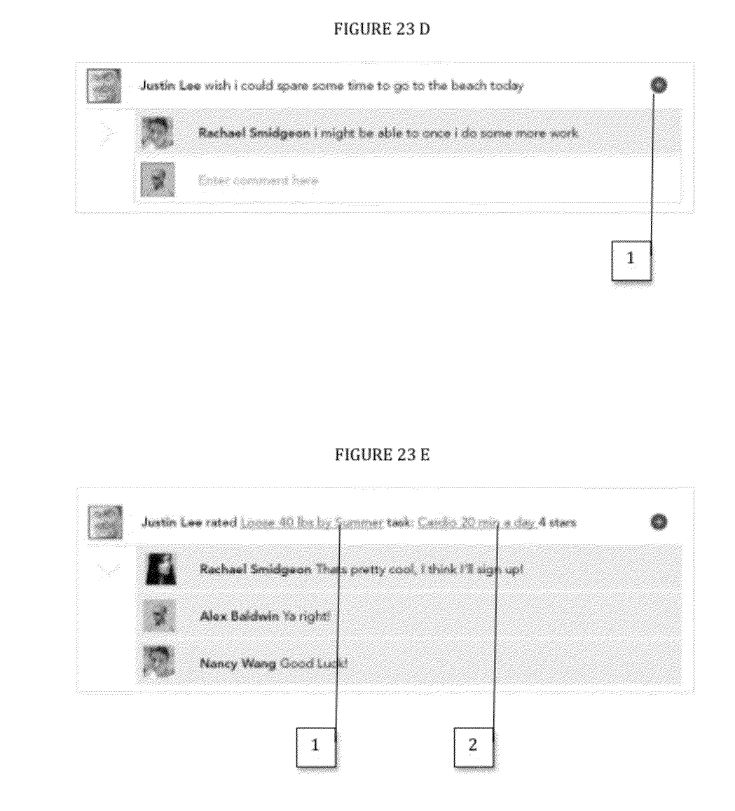

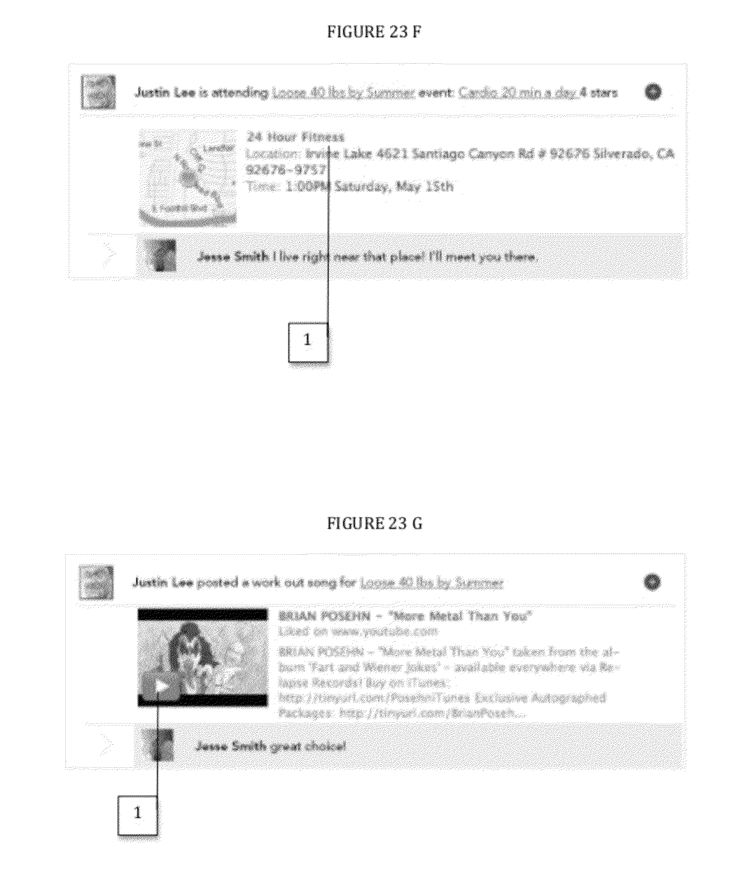

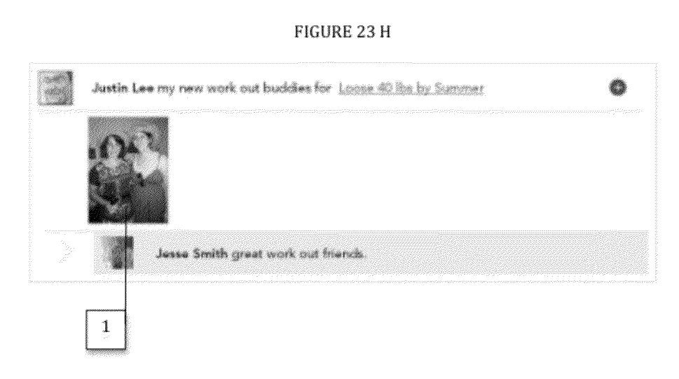

If the user is logged in and clicks one of their goals they will be taken to their GOAL PAGE UPDATES TAB 2, as illustrated in FIG. 23A. If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE—UPDATES TAB. If the user is visiting a goal page and they are not friends they will not be able to send a message onto the UPDATES TAB. They will have to be added as a friend or if the user allows strangers to send a personal message they can send a personal message.

User will be able to post text FIG. 23B, pictures FIG. 23H, videos and links FIG. 23G, and events FIG. 23F. Also, whenever the user does or completes something goal related the system will automatically post this onto the GOAL PAGE UPDATES TAB where other users can comment on it. An example of this is FIG. 23E where user Justin Lee rated the task of “Cardio 20 min a day” for the goal “Loose 40 lbs by Summer” and rated it with four stars. The user can click this link 1 and it will take them to that GOAL PAGE where they can start it or view its page or if the user already has that goal they can click 2 to add this to their Master List of the goal.

Users can comment on anything posted. If there are one or more comments on a post the newest comment will be shown FIG. 23B. If the user wants to see more comments the user can click the arrow to drop down all the comments 1, as illustrated in FIG. 23C. If the user wishes to post a comment they can by clicking 1, as illustrated in FIG. 23D and a comment area box will show. Posting an event FIG. 23F will allow the user to click on the link title 1 and it will bring up the event on its own page showing who is attending and more detailed information. Posting a video FIG. 23G will allow the user to click 1 and the video will pop up playing the video. Pictures can be posted FIG. 23H. They can be clicked to show the picture large on its own page with all the comments from the album the picture was posted to.

### 23. Goal Page—Master List

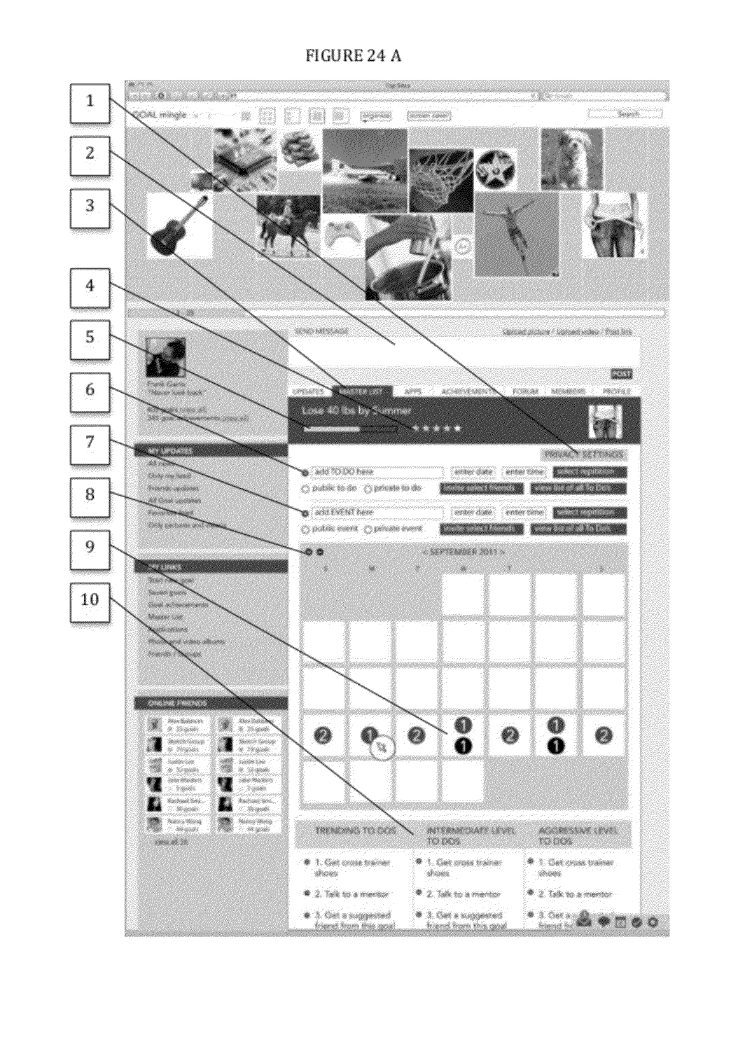

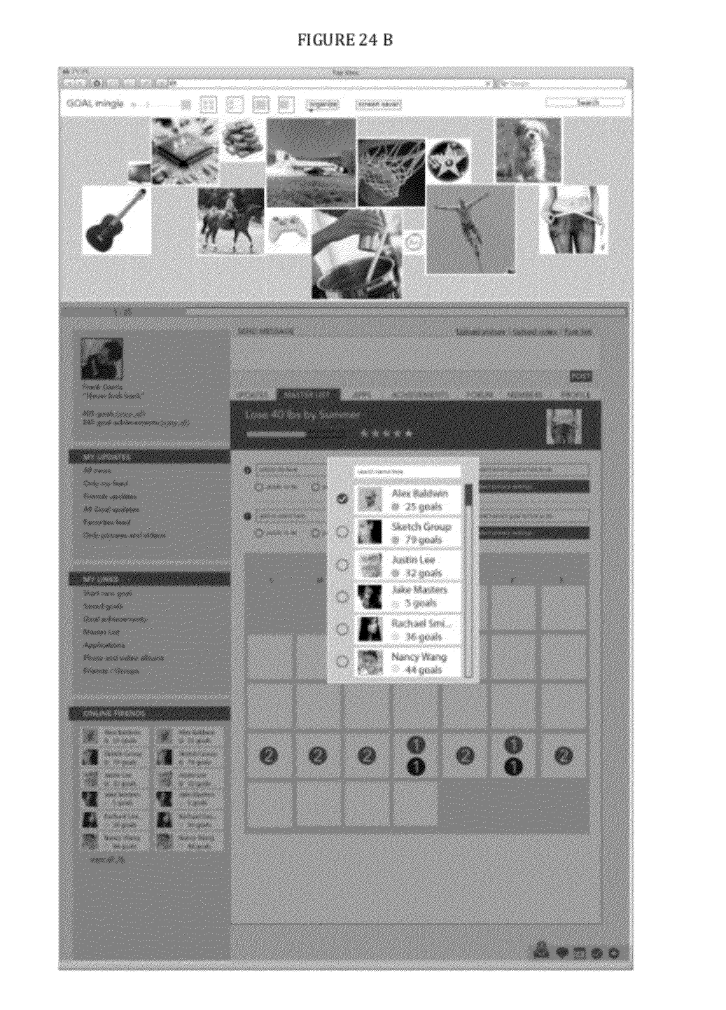

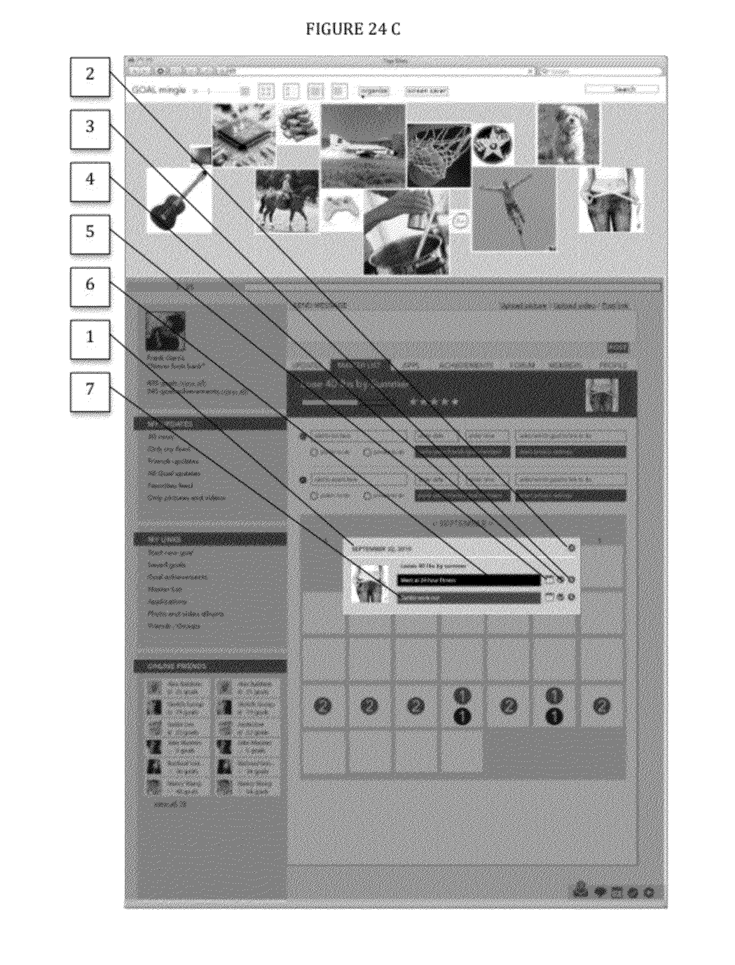

As illustrated in FIG. 24A, All calendar events and To-Do's for a specific goal are here in the MASTER LIST 2 tab. User can click to view and edit all goal specific To-Do's and Events. User can customize To-Do's and Events to also include friends and/or goal members (see FIG. 24B).

If the user is on their own or a friends USER PAGE TABS messages posted 1 here will be seen by other friends in their friends USER PAGE—UPDATES TAB, and in the users own USER PAGE—UPDATES TAB. If the user is visiting on another persons page and they are not friends they will not be able to send a message onto the UPDATES TAB. They will have to be added as a friend or if the user allows strangers to send a personal message they can send a personal message. User can add any To-Do 5 or Event 6 and be able to link it to a goal. The To-Do and/or the Event can be seen from this tab or on the specific goal page Master List. All To-Do's will have a teal border around the image or a teal circle with amount of To-Do's if more than four items are on a specific calendar date. All Events will have a black border around the image or a black circle with amount of Events if more than four items are on a specific calendar date.

After each To-Do is completed user will have to rate the To-Do so the system can better suggest To-Do's to others. System will average the completed To-Do's and give the goal an overall rating 4. Also based on how many To-Do's are completed and how many are left to complete goal, the system will have a progress bar showing how far from completion of goal 3. Goal calendar will not show images but only numbers. If there are multiple To-Do's and Events for a specific goal date then two numbers will show 7, teal referencing To-Do's and black referencing Events. If the number is clicked a pop up will show with the To-Do's and/or Events for that calendar date, as illustrated in FIG. 24C. The date will show 1, an close pop up button 2, edit To-Do or Event button 5, mark the To-Do or Event as completed 4, and a cancel To-Do or Event button 3. The To-Do 6 or Event 7 can be clicked to view item on a whole page with complete detailed information of To-Do or Event with user, friend and/or member comments and/or pictures, maps, requirements, people attending and more.

### 24. Goal Page—APPS Tab

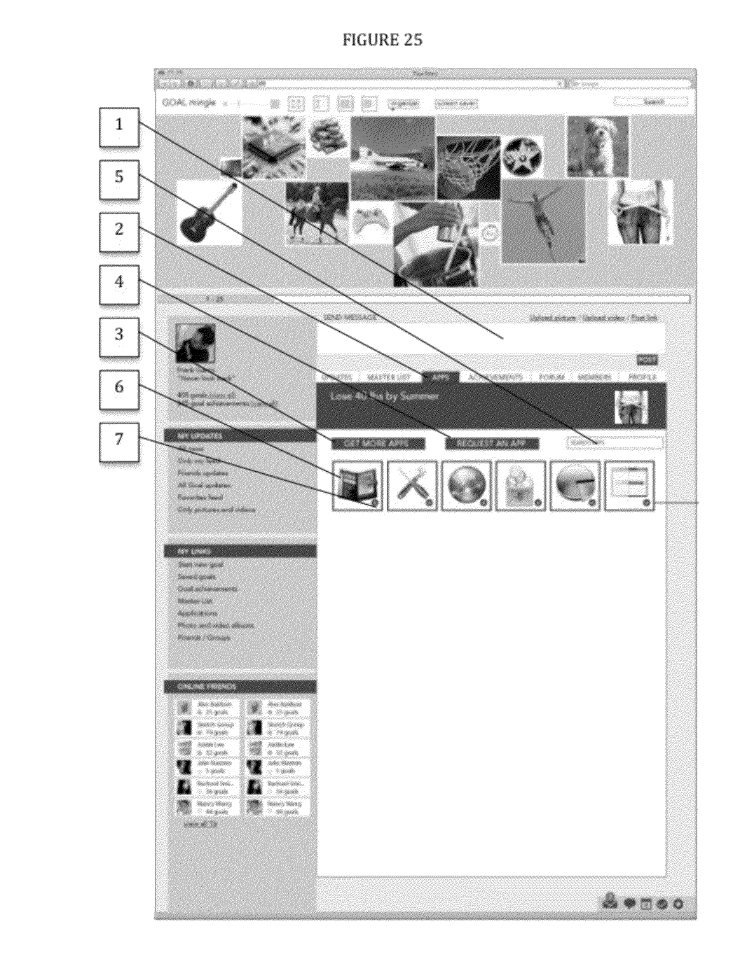

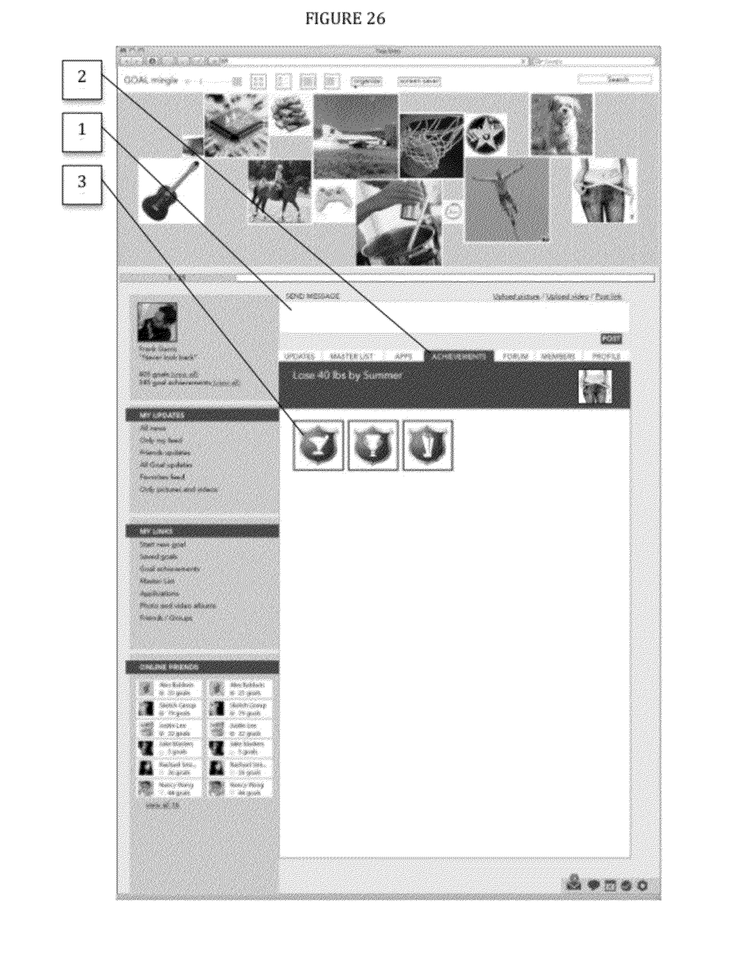

The user may collect apps to be in their GOAL PAGE—APPS TAB, illustrated in FIG. 25. All apps will be shown that are made for that goal. Apps will help them achieve certain goals. Clicking an app image 6 will have a pop up window with the app so that they can have multiuse apps running at the same time viewed at the same time. Hovering over the app will show app name and short description. Apps will also have the option of deletion right from the page 7.

If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE—UPDATES TAB. If the user is visiting a goal page and they are not friends they will not be able to send a message onto the UPDATES TAB. They will have to be added as a friend or if the user allows strangers to send a personal message they can send a personal message. If the user has an idea for an app they can request 4 it to be made by the system or another client. By requesting an app we will receive an email of their idea and we can use the information as we like. Users can also get more apps 3 and this will take them to a page full of apps created for this goal and be able to see apps for other goals as well. If the user has a lot of apps on this page they can search by entering keywords 5.

### 25. Goal Page—Achievements Tab

All awards given to the user by goal presidents/creators are viewed here 2 like trophies FIG. 26. Hovering over 3 will say the name of the achievement, the goal name, and a short description. Clicking on the achievement will take the user to that goal page. If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE—UPDATES TAB. If the user is visiting a goal page and they are not friends they will not be able to send a message onto the UPDATES TAB. They will have to be added as a friend or if the user allows strangers to send a personal message they can send a personal message.

26. GOAL PAGE—FORUM TAB

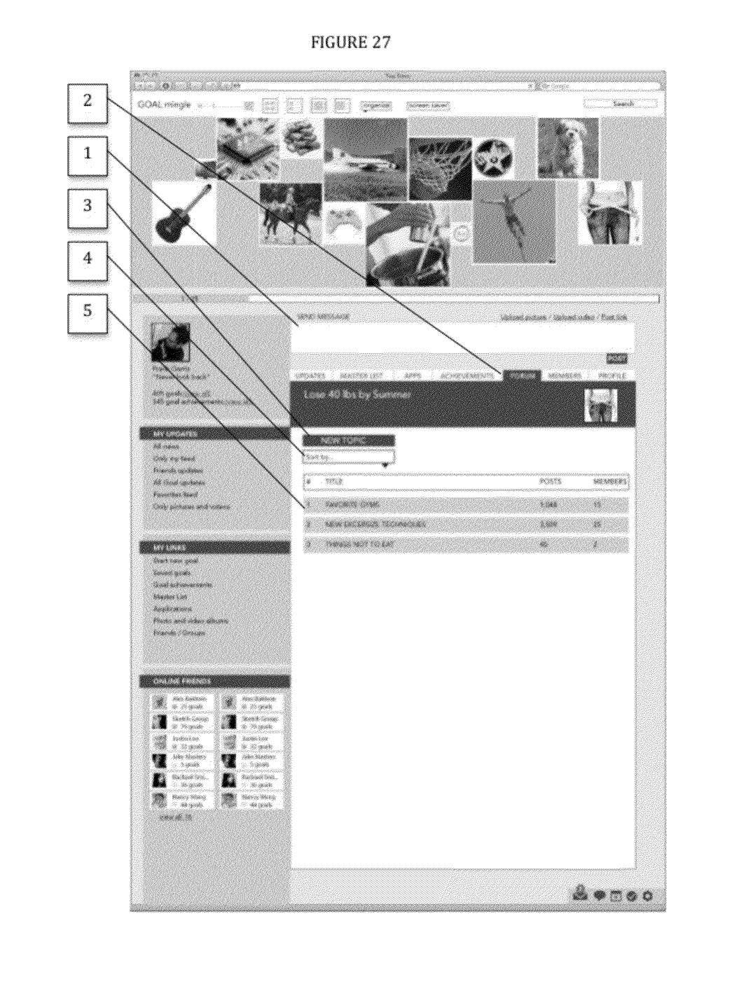

Questions and discussions are posted 2, as illustrated in FIG. 27 here specific to this goal to build a database of information. If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE UPDATES TAB. If the user is visiting a goal page and they are not friends they will not be able to send a message onto the UPDATES TAB. They will have to be added as a friend or if the user allows strangers to send a personal message they can send a personal message. New topics 3 can be created by anyone who has joined this goal and can be sorted 4 by title alphabetically, how many posts, date started, or how many users contributed to the post. Any users visiting the page can click on a title 5 to view its contents but only users that joined this goal can leave a comment or start a new topic.

### 27. Goal Page—Members Tab

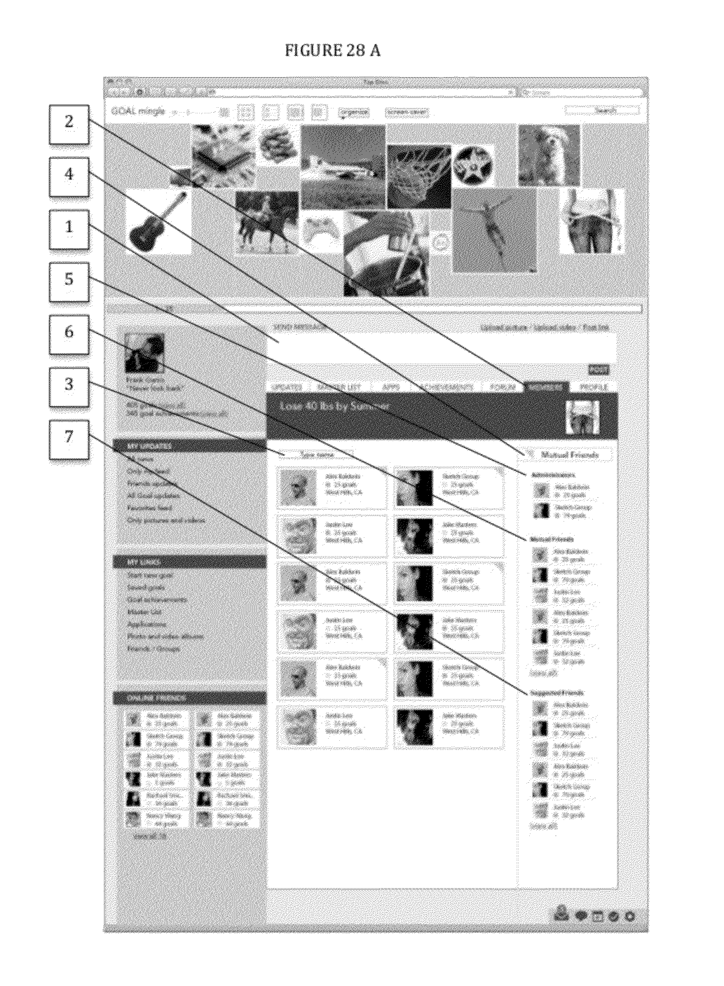

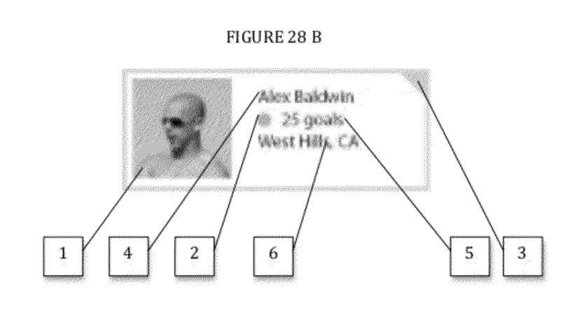

In the GOAL PAGE—FRIENDS TAB 2, illustrated in FIG. 28A, the user will see their list of all friends and a list of suggested friends 6 by the system who have similar profiles, goal choices, and achievements. If the user is visiting someone else's page there will be another list of mutual friends 4. Mutual friends will also be marked in the general alphabetical list. If the user wants to search this friend page for a particular friend or a friend containing certain letters they can type it in the search bar 3.

If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE—UPDATES TAB. If the user is visiting a goal page and they are not friends they will not be able to send a message onto the UPDATES TAB. They will have to be added as a friend or if the user allows strangers to send a personal message they can send a personal message.

The administrators of the created goal will be shown 5. Also shown are the mutual friends of the visiting user and suggested friends for users related to this goals. There should only be a minimum amount of friends shown in the mutual friends or suggested friends column. If the user wants to view all of the mutual friends 6 or all of the suggested friends 7 the user can do so and it will bring up a pop up list of all the friends.

All of the friends are displayed with the following (see FIG. 28B): user profile picture 1, user or group name 4, online status position 2 (green for active online, yellow for idle for more than 10 minutes online, or white for offline), how many active goals the friend has 5, and location 6. If the user is visiting another friends page and the user and friend have another mutual friend there will be a marker 3. If the user clicks a friend image the user will be taken to their user page.

### 29. Goal Page—Profile Tab

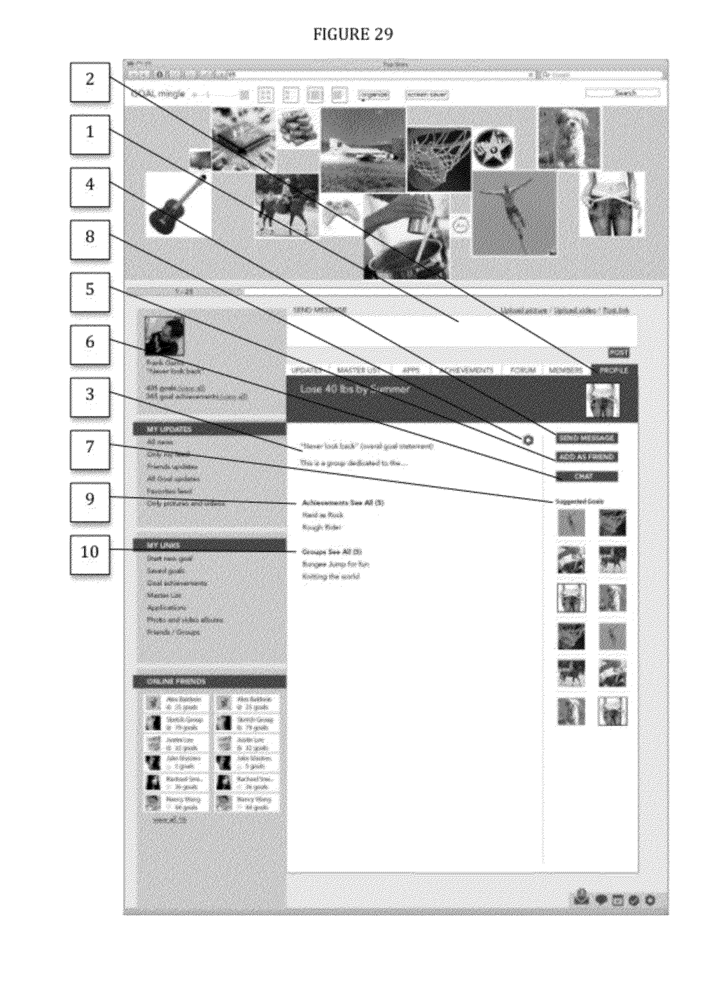

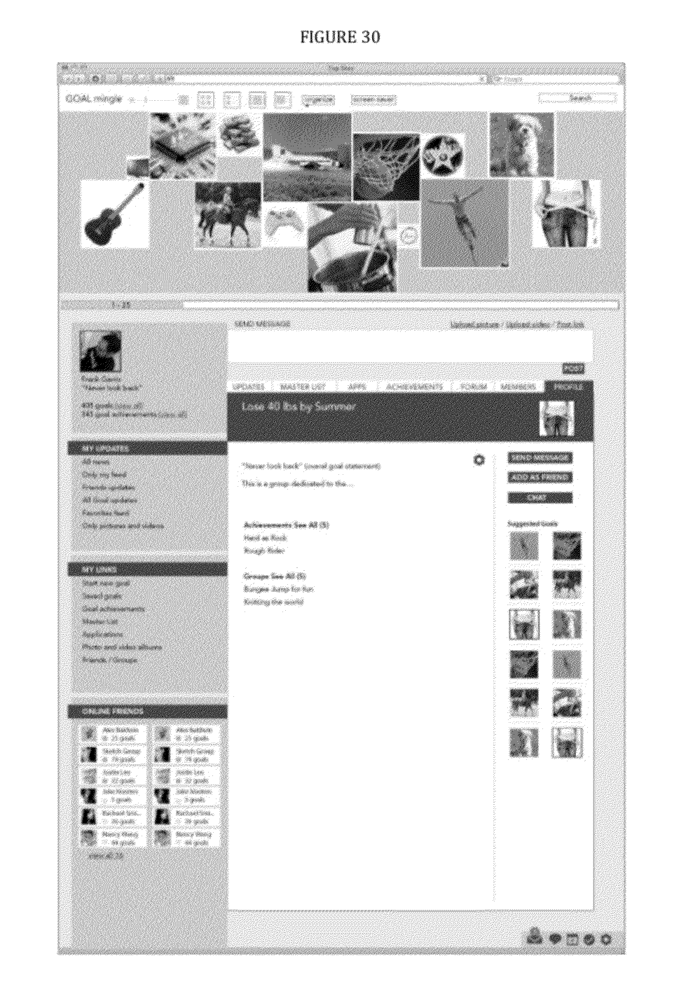

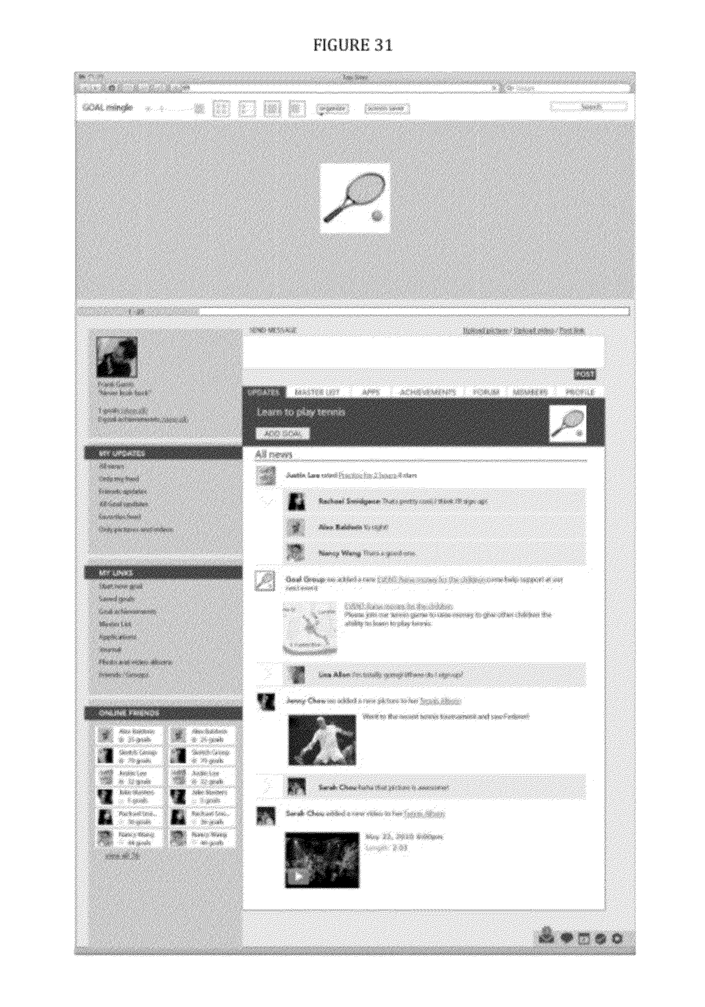

In the GOAL PAGE—PROFILE TAB 2 (See FIG. 29) there will be basic information about the goal. If the user is on their own or a friends GOAL PAGE—MASTER LIST TAB messages posted 1 here will be seen by other friends in their friends USER PAGE—UPDATES TAB, in the users own USER PAGE—UPDATES TAB, and in the GOAL PAGE—UPDATES TAB. If the user is visiting a goal page and they are not friends they will not be able to send a message onto the UPDATES TAB. They will have to be added as a friend or if the user allows strangers to send a personal message they can send a personal message.

Overall goal statement and description of the goal 3, possible goal achievements given by the goal administrators 9, and groups the goal in involved with 10 are shown. If the user is one of the administrators or creators of the goal they will be able to see 8 and if clicked they can edit the fields of information.

If the user is visiting this page they can 4 send the goal a message which any of the administrators can respond to, they can add the goal 5 and then begin their Master List (see FIG. 24), or if one of the administrators are logged in the chat option 5 will show and they visiting user will be able to chat with the administrator.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

1. A computer implemented method of suggesting at least one goal and at least one list item to a user, the method comprising:
receiving in a network at least some personal interest information of a first user;
determining at least one goal for the first user wherein the at least one goal is correlated to the at least some personal interest information of the first user and at least some personal interest information and at least one goal of at least a second user in the network;
determining the at least one list item for the first user wherein the at least one list item is correlated to the at least some personal interest information of the first user and the at least some personal interest information and at least one list item of the at least second user in the network wherein the at least one list item of the at least a second user in the network is associated with the at least one goal of the at least a second user in the network; and
displaying to the first user the at least one goal and the at least one list item.

2. The method of claim 1 further comprising receiving a modification of the at least one list item by the first user.

3. The method of claim 1 further comprising weighing rank of the at least one list item of the at least second user by users in the network in determining the at least one list item.

4. The method of claim 1 wherein the at least one list item of the at least a second user and the at least one goal of the at least a second user are unrelated.

5. The method of claim 1 wherein the at least one goal of the at least a second user is completed.

6. A computer implemented method of suggesting at least one goal to a user, the method comprising:
receiving in a network at least some personal interest information of a first user;
determining at least one goal for the first user wherein the at least one goal is correlated to the at least some personal interest information of the first user and at least some personal interest information and at least one goal of at least a second user in the network; and
displaying to the first user the at least one goal.

7. A system of suggesting at least one goal and at least one list item to a user, the system including processor executable instructions embodied in at least one computer readable media, memory, or computer readable device, comprising
a receiving module for receiving in a network at least some personal interest information of a first user;
a first determination module for determining at least one goal for the first user wherein the at least one goal is correlated to the at least some personal interest information of the first user and at least some personal interest information and at least one goal of at least a second user in the network;
a second determination module for determining the at least one list item for the first user wherein the at least one list item is correlated to the at least some personal interest information of the first user and the at least some personal interest information and at least one list item of the at least second user in the network wherein the at least one list item of the at least a second user in the network is associated with the at least one goal of the at least a second user in the network; and
a displaying module for displaying to the first user the at least one goal and the at least one list item.

8. A non-transitory computer-readable medium containing program code comprising: program code for suggesting at least one goal and at least one list item to a user, comprising:
program code for receiving in a network at least some personal interest information of a first user;
program code determining at least one goal for the first user wherein the at least one goal is correlated to the at least some personal interest information of the first user and at least some personal interest information and at least one goal of at least a second user in the network;
program code determining the at least one list item for the first user wherein the at least one list item is correlated to the at least some personal interest information of the first user and the at least some personal interest information and at least one list item of the at least second user in the network wherein the at least one list item of the at least a second user in the network is associated with the at least one goal of the at least a second user in the network; and
program code displaying to the first user the at least one goal and the at least one list item.

9. A method of providing information to a user in a network, comprising:
receiving in a network at least some personal interest information of a first user;
determining at least one goal for the first user wherein the at least one goal is correlated to the at least some personal interest information of the first user and at least some personal interest information and at least one goal of at least a second user in the network;
determining the at least one list item for the first user wherein the at least one list item is correlated to the at least some personal interest information of the first user and the at least some personal interest information and at least one list item of the at least second user in the network wherein the at least one list item of the at least a second user in the network is associated with the at least one goal of the at least a second user in the network;
displaying to the first user the at least one goal and the at least one list item; and
displaying to the first user at least one advertisement associated with at least one of the at least one goal and the at lest one list item.
